(19) United States
(12) Patent Application Publication
(10) Pub. No.: US 2009/0315715 A1
(43) Pub. Date: Dec. 24, 2009

(54) INTERACTIVE DESK UNIT

(76) Inventor: Jan PT Larsen, Hudson, WI (US)

Correspondence Address: SCHWEGMAN, LUNDBERG & WOESSNER, P.A., P.O. BOX 2938, MINNEAPOLIS, MN, 55402, US

(21) Appl. No.: 12/483,773

(22) Filed: Jun. 12, 2009

Related U.S. Application Data
(60) Provisional application No. 61/073,209, filed on Jun. 17, 2008.

(51) Int. Cl. G08B 13/14; H04L 17/02

(52) U.S. Cl. 340/568.1; 341/176

(57) ABSTRACT

Various embodiments include an apparatus comprising a master control unit, one or more output devices coupled to the master control unit, the one or more output devices operable to provide observable outputs in at least one room, the master control unit operable to control one or more parameters of the observable outputs and at least one desk unit including an input device, the input device operable to generate input signals based on actuation of the input device, and to provide the input signals to the desk unit, the desk unit operable to be communicatively linkable to the master control unit, the master control unit operable to select and to un-select the desk unit so that when the desk unit is selected, the selected desk unit is operable to communicate the data related to the generated input signals to the master control unit in order to control at least one of the one or more parameters.

### CROSS REFERENCE TO RELATED APPLICATION(S)

This present application is a U.S. Application which claims the benefit of U.S. Provisional Application Ser. NO. 61/073,209, filed Jun. 17, 2008, the entire contents of which are hereby incorporated herein by reference in its entirety.

### BACKGROUND

Modern classrooms, for example classrooms used in elementary, junior high, and high schools, sometimes employ one or more types of electronic equipment as aids in the educational process. For example, a projector can be used to project images onto a screen that is viewable by all of the students in the classroom. In another example, a video or a movie that includes both video information provided on a screen, such as a movie screen or a television screen, along with the associated audio information provided in the same room, can be utilized to provide educational information to students in a classroom.

These pieces of electronic equipment are often not integrated with any of the other equipment available in the classroom. In many instances, each piece of equipment must be operated from the equipment itself, wherein the controls for the particular piece of equipment are located on the piece of equipment itself. In many instances, these controls are strictly operable to control a single piece of equipment, and do not have the capability to control any other piece of equipment that might be available for use in the same classroom.

### BRIEF DESCRIPTION OF THE FIGURES

The embodiments of the present inventive subject matter are illustrated by way of example and not limitation in the figures of the accompanying drawings, in which like references indicate similar elements and in which:

FIG. 1A illustrates a system according to various embodiments;

FIG. 1B illustrates a diagram of a selection table according to various embodiments;

FIG. 2A illustrates a diagram of a desk having a built-in desk unit according to various embodiments;

FIG. 2B illustrates a pad area according to various embodiments;

FIG. 2C illustrates a desk unit according to various embodiments;

FIG. 3 illustrates a beacon signal according to various embodiments;

FIGS. 4A-C illustrate waveforms included in beacon signals according to various embodiments;

FIG. 5 illustrates waveforms according to various embodiments;

FIGS. 6A-B illustrate a remote according to various embodiments;

FIG. 7 illustrates a base station according to various embodiments;

FIG. 8 illustrates a flowchart for various methods according to embodiments of the present invention;

### DETAILED DESCRIPTION

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the subject matter described herein. It is intended that this subject matter be limited only by the claims, and the full scope of equivalents thereof.

Such embodiments of the subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

Embodiments of the present inventive subject matter include apparatus, systems, and methods for incorporating one or more selectable desk units into an integrated communication system. In various embodiments, each one of the selectable desk units can be individually selected to have control over one or more particular parameters of the communication systems. By way of illustration, an image of a computer screen that is projected onto a screen viewable by the students in a classroom includes a moveable cursor as part of the image. In various embodiments, any one of the selectable desk units can be selected to have control over the movements of the movable cursor, so that inputs from the now selected desk unit control the movements of the cursor on the screen that is viewable by the entire classroom.

In various embodiments, a master control unit is operable to control which of the selectable desk units is selected to have control over the one or more parameters of the communication system. By way of illustration, a master control unit is operable to receive inputs from a device controlled by a designated teacher in the classroom, wherein the teacher, by providing inputs to the master control unit, can selectively activate a given one of the selectable desk units to allow the selected desk unit to have control over one or more of the parameters of the communication system.

In various embodiments, the master control unit is operable to allow selection of a plurality of the selectable desk units so that the selected desk units have control over one or more of the parameters of the communication system. By way of illustration, a plurality of selectable desk units can be selected to provide inputs, such as control over a curser displayed as part of a display of a computer screen viewable by all the students, or to have text being typed at each of the plurality of desk units displayed on a common screen that is viewable by the students in the classroom.

In various embodiments, the master control unit is operable to allow selection of a plurality of selectable desk units, wherein each of the individual desk units is designated to have control over one or more parameters of the communication system that are different from the parameters that at least one of the selectable desk units has been given control over.

In various embodiments, one or more of the desk units include a transmitter/receiver unit operable to allow the desk units to be communicatively coupled to a master control unit. In various embodiments, one or more of the desk units include an Input/Output unit that is operable to process input signals from one or more input devices coupled to the desk unit, and to provide outputs, such as output data and output signals, based on the signals from the one or more input devices. In various embodiments, any combination of the output data and the output signals are provided to the transmitter/receiver unit for transmission to the communication system, wherein the output data, the output signals, or both the output data and the output signals are used to control one or more parameter of the communication system when the desk unit providing the outputs has been selected.

In various embodiments, the transmitter/receiver is operable to receive a signal indicating that the desk unit that includes the transmitter/receiver has been selected by the master control unit to have control over some parameter or parameters of the communication system. In various embodiments, the transmitter/receiver unit is operable to receive a signal indicating that the desk unit that is currently selected is now un-selected, and will no longer have control over any of the parameter of the communication system. In various embodiments, the transmitter/receiver unit is operable to receive signals that configure the desk unit so that the desk unit controls a different parameter or set of parameters than that the desk unit was previously selected to control.

In various embodiments, control over the selection of desk units, the un-selection of desk units, and control over which parameters are to be controlled with respect to each of the desk units is provided by a selection mechanism that is controllable by the designated teacher through a device communicatively coupled to the master control unit. Various embodiments of the selection mechanism are described in further detail herein.

Embodiments of the present inventive subject matter can include apparatus, systems, and methods for communications between one or more remotes and one or more base stations coupled included in the communications system. The remotes are operable to automatically establish bi-directional communications between the given remote and any one of the base stations in a system, while avoiding interference and cross talk between the given remote and any other remotes operating in close proximity, and while avoiding interference and cross talk between the given remote and any base station in the system besides the base station the given remote has established bi-directional communications with. In various embodiments, each remote automatically turns on and establishes bi-directional communications with a base station upon entering a room where the base station is operating, and automatically shuts off upon exiting the room where the base station is operating.

In various embodiments, the one or more remotes are operable to move between enclosures, such as but not limited to rooms in a building or other structure, wherein each of the enclosures includes a different base station, and to establish bi-directional communications with the base station in the enclosure where the remote is located without having to re-program the remote.

In various embodiments, the remote is operable to communicate separately and at any given time with any one of the base stations when the remote is within an approximate line-of-sight transmission space of the base station. An approximate line-of-sight transmission space refers to the space around a source of a signal into which the signal, when transmitted, would reach with a sufficient signal strength to be detectable by the one or more remotes. An approximate line-of-sight transmission space is not limited to space having only a direct visual line of sight to the source of the signal, and may include space receiving the signal as a result of reflections of the signal off any objects or surfaces capable of reflecting the transmitted signal to some extent, and may include transmission of the signal through objects that permit the signal to pass through.

By way of illustration and not by way of limitation, a typical wall within a building does not allow the penetration of a transmitted signal having a wavelength in the infrared frequency range. Therefore, space beyond a wall on the opposite side of the wall from the source of an infrared signal would typically be outside the approximate line-of sight transmission space for the signal. However, in various instances the side of the wall facing the source of the signal may be reflective of the signal to some extend, and thus provides reflected portions of the signal to areas on the side of the wall facing the source of the signal that may not otherwise be in a direct line-of-sight with the source of the signal, but nonetheless are included in the approximate line-of-sight transmission space due to receiving the reflected portions of the signal reaching the space.

A line-of-sight transmission signal is a signal, such as but not limited to an infrared signal, that, when transmitted, substantially fills an approximate line-of-sight transmission space, either through direct line-of-sight transmission or though reflection or transmission through an object, or though both direct line-of-sight transmission and through reflection or transmission through an object, and does not penetrate through solid objects. In one embodiment, the line-of-sight transmission signal frequency is selected such that solid objects include but are not limited to walls, ceilings, and floors used in building structures, such as but not limited to homes, schools, hospitals. In one embodiment, the line-of-sight transmission signal frequency is selected such that solid objects include the physical structures used to construct passenger areas within vehicles such as automobiles, buses, aircraft, and boats.

In various embodiments, each of the base stations provide a beacon signal including an electromagnetic energy transmitted at a wavelength having a non-radio frequency, such as but not limited to a frequency having an infrared wavelength, or a frequency having a wavelength within the visible light spectrum. In various embodiments, the beacon signal is a sound wave having, for example, an ultrasonic frequency. In one such embodiment, the beacon signal indicates to any remote within an approximate line-of-sight transmission space of the base station the information needed to establish bi-directional radio frequency communications between the base station and the remote.

In various embodiments, the beacon signal is a high power, short duration signal produced and transmitted by the base station. In various embodiments, the beacon signal includes a sufficient amount of power so as to provide a beacon signal having a sufficient signal strength to be detected by one or more remotes located anywhere within a enclosure where a source providing the beacon signal is located. In one such embodiment, the signal strength is chosen to limit detection of the beacon signal outside the enclosure.

In various embodiments, the base station producing and transmitting the beacon signal is powered from a line source rather than a battery source. This feature allows the high power beacon signal to be provided without the need for the large power requirement needed to produce the beacon signal being made on a battery operated device. In various embodiments, the remotes are operable so that the remotes receive the beacon signal transmitted at the line-of-sight transmission signal frequency, but transmit and receive information at a radio frequency. Since the radio frequency transmissions and receptions are low power operations compared to the transmissions of the beacon signals, such an approach enables efficient and long operating periods for the remotes using battery power.

In various embodiments, the beacon signal is used as a locator beacon signal in order to allow remotes to determine when they are in an area where bi-directional communications between a given remote and a given base station can be established, and to indicate the wavelength or wavelengths of radio frequencies the bi-directional communications can be established on.

In various embodiments, the frequency used to transmit the beacon signals is a pre-determined standard frequency. By way of illustration, industrial standards may exist in different countries for the use of infrared frequencies in order to enable compatibility of devices sold for operation in these countries. However, these requirements may not be jurisdictionally dictated by the governmental or regulatory agency having jurisdiction in the region, area or country where embodiments of communication systems are being operated.

By way of illustration, industrial standards for devices transmitting and receiving electromagnetic signals with wavelengths in the infrared frequency range may operate at standardized frequencies of 28, 32, 36, 38, 40, 56 and 455 kilohertz. The 28, 32, 36, 38, 40, and 56 kilohertz frequencies are typically used in the United States, while the 455 kilohertz frequency is typically used in Europe. However, these standards are not required by the judiciary or regulatory bodies having regulatory authority in these countries. Therefore, a device may operate on any of these, or different wavelengths, within the infrared range of frequencies. Thus, use of infrared wavelength transmissions may not be restricted to or limited to only the frequencies depicted by the standards, and thus transmissions on frequencies, such as other infrared frequencies, that are different from the frequencies of the standards for the area where embodiments of the communication system are installed would not violate the jurisdictional regulations.

By operating the beacon signals in one of these industrial standard frequency ranges, in various embodiments base stations, such as but not limited to base station 112, can use one or more commercially available off-the-shelf circuits for use in generating and transmitting the beacons signals. In various embodiments, remotes, such as but not limited to remotes 110 and 119, can use one or more commercially available off-the-shelf circuits to receive and process the beacon signals. In various embodiments, base stations and remotes are operable to use a standard frequency for the beacon signal that is a standard dicited by a different standard generally used in a country or region in which the base stations and remotes are operated, but in a manner that does not violate any of the jurisdictional regulation of the country or region in which the base stations and remotes are intended to operated.

By way of illustration, a communication system intend to operate in the United States is designed to have base stations that operate at standard frequencies designated for use in another jurisdiction, for example Europe. By using a standard frequency from Europe, base stations and remotes can still be built using commercially available off-the-shelf circuits, that include circuits intended for European use, while at the same time minimizing the chance of interfere with other devices that may be used in proximity to base stations and remotes, such as a wireless mouse, a wireless keyboard, a television remote control, or a wireless hand held device such as a personal digital assistant (PDAs). Since these devices are most likely operating on the frequency of the standards used in the Unites States, use of the European standard frequency minimized the change of interfering with the other devices while still not violating any jurisdictionally dictated regulations and still allowing the use of commercially available off-the-shelf parts.

In various embodiments, bi-directional communications include transmitting and receiving wavelengths having frequencies within the range of radio frequency signals. Radio frequencies have a wide range of wavelengths. Jurisdictionally determined radio frequency standards include frequency assignments dictated by a governmental or regulatory agencies having authority to assignee and regulate transmission of signals in a designated area, region, or country. For example, in the United States the Federal Communications Commissions FCC was established by the Communications Act of 1934 as the successor to the Federal Radio Commission and is charged with regulating all non-Federal Government use of the radio spectrum (including radio and television broadcasting), and all interstate telecommunications (wire, satellite and cable) as well as all international communications that originate or terminate in the United States. The FCC's jurisdiction covers the 50 states, the District of Columbia, and U.S. possessions.

In various embodiments, each base station is operable to establish bi-directional communications on any one of a plurality of channels within a range of radio frequencies. In various embodiments, each base station is operable to establish bi-directional communications on any one of a standard channel designed by some recognized standard. In various embodiments, each base station is operable to establish bi-directional communications on any of the ninety-eight channels having wavelengths in the frequency range between 2.400 gigahertz and 2.498 gigahertz.

In various embodiments, one or more of the desk unit communicatively coupled to a compunction system is operable to establish bi-directional communications with a master control unit using any of the techniques described herein for the bi-directional communications between a base station and a remote.

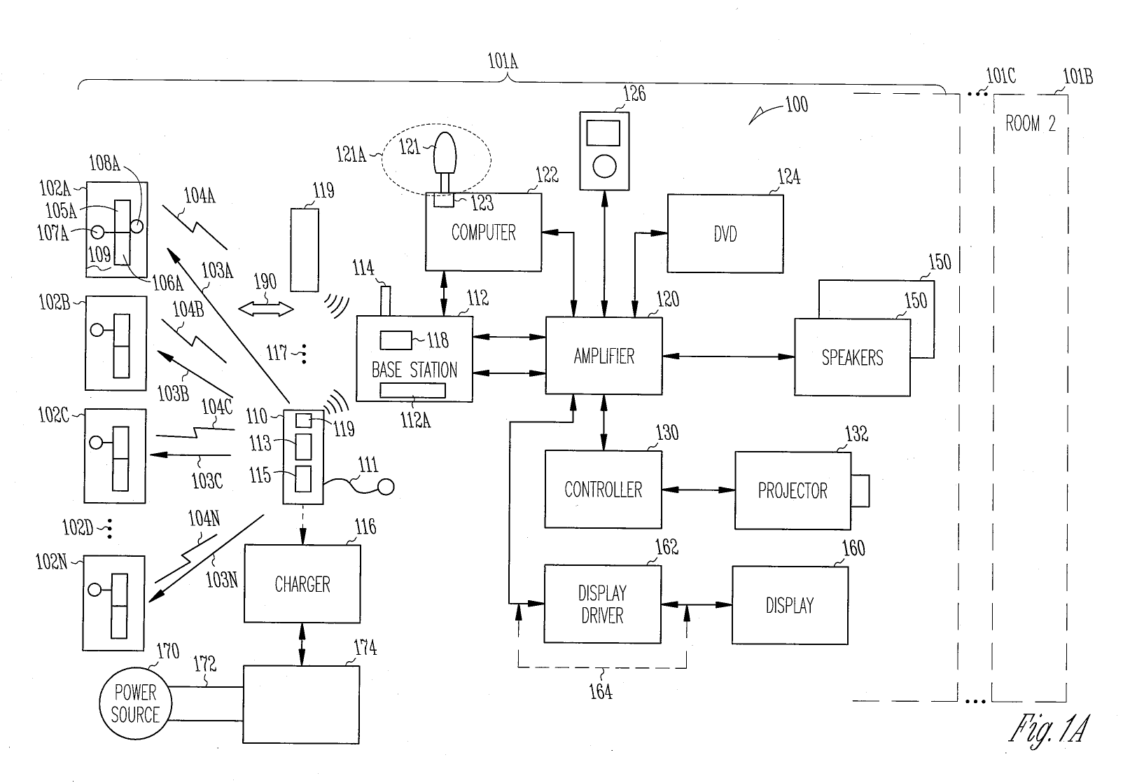

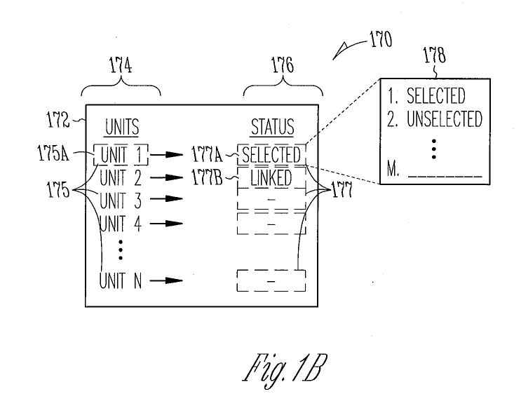

FIG. 1A illustrates a communication system 100 according to various embodiments. In various embodiments, communication system 100 includes one or more devices communicatively coupled in a first room 101A. In various embodiments, communication system 100 includes one or more devices communicatively coupled in a second room 101B. In various embodiments, the first room 101A and the second room 101B are adjacent to one another, and in some embodiments, share a common divider, such as a wall 101C. In various embodiments, the communication system in room 101A can operate at the same time, or during overlapping periods of time, as the communication system in room 101B. It would be understood that in various embodiments include a room 101A, and in other embodiments of communication system 100 can include additional rooms including additional communications systems (not shown in FIG. 1A). These communication systems can operate in adjacent proximity to one an other without interfering with, and without cross communications occurring, between room 101A and any other room, including room 101B, as further described herein.

Room 101A and 101B are not limited to any particular type of room. In various embodiments, room 101A and 101B include a classroom, a board room, or any other type of enclosure operable to allow persons to enter and exit, and to generally be either seated or standing, or both within the area of the room.

In various embodiments, communication system 100 includes any combination of a base station 112, an amplifier 120, a computer 122, a digital video disk (DVD) player 124, a camera 126, controller 130, projector 132, speakers 150, and display 160. In various embodiments, display 160 is coupled to amplifier 120 through display driver 162, or does not require a display driver, as indicated by dotted line 164. It would be understood that system 100 can include any combination of the devices shown in FIG. 1A, or addition device, including more of any particular one of the devices as shown in FIG. 1A. By way of illustration, it would be understood that communication system 100 can include more than one computer 122 coupled to communication system 100.

In various embodiments, system 100 includes an amplifier 120 coupled to one or more devices and operable to receive inputs from the one or more devices, process the received inputs, and provide outputs to one or more devices. Devices include but are not limited to computer 122, digital video disk (DVD) player 124, camera 126, controller 130 and projector 132, speakers 150, and display 160. In various embodiments, display 160 is coupled to amplifier 120 through display driver 162, or does not require a display driver as indicated by dotted line 164.

In various embodiments, outputs from the communication system 100 include observable outputs. Observable outputs are not limited to any particular type of outputs, and can be any types of outputs, including but not limited to video and audio outputs, that are in general observable by a person or persons who are present in a room where the observable outputs are being provided by way of illustration, an observable output can include a display provided on a screen or on an electronic display that is arraigned to be viewable by one or more persons that are present in a room where the screen or the electron display is located. In another illustration, an observable output can include audio outputs that can be generally heard by persons present in the room where the audio outputs are being provided. In various embodiments, the observable outputs can be provided by any combination of the devices included in communication system, such as communication system 100.

Referring again to FIG. 1A, amplifier 120 is not limited to any particular type of amplifier. Amplifier 120 can include any amplifier capable of receiving inputs and processing the inputs to provide outputs. In various embodiments, amplifier 120 is operable to amplify received signals, including but not limited to audio signals, video signals, and control input signals. Control input signals are not limited to any particular type of signals, and include any type of signals including control information or data associated with any of the devices included in communication system 100.

In various embodiments, communication system 100 includes a base station 112. Base station 112 is not limited to any particular type of base station. In various embodiments, base station 112 is communicatively coupled to a remote 110, and is operable to provide both one-way beacon signals to remote 110, and to establish bi-directional communications between the base station 112 and the remote 110, as further described herein. In various embodiments, base station 112 includes one or a plurality of antenna 114 operable to transmit and receive signals to and from remote 110. In various embodiments, remote 110 and base station 112 are operable to establish bi-directional communications at a wavelength transmitted and received at the beacon signal frequency range, and to establish bi-directional communications at wavelength operating in a radio frequency range.

In various embodiments, base station 112 includes transmitter 118 operable to transmit a beacon signal. In various embodiments, the transmitted beacon signal is a line-of-sight transmission signal, wherein the transmitted beacon signal is transmitted into a line-of-sight transmission space surrounding base station 112. In various embodiments, the transmitter 118 is operable to transmit the beacon signal at a wavelength in the infrared frequency range. In some embodiments, transmitter 118 is a transceiver operable to both transmit and receive signals in the infrared frequency range. In various embodiments, transmitter 118 includes a transceiver operable to transmit and receive signals on a plurality of wavelengths in the radio frequency range.

The beacon signal is operable to be received by any remotes, such as but not limited to remote 110, and to provide remote 110 with information for establishing bi-directional communications between the remote 110 and the base station 112. In various embodiments, base station 112 and remote 110 are operable to perform the bi-directional communications between base station 112 and remote 110 at wavelengths in the radio frequency range. In various embodiments, base station 112 and remote 110 are operable to perform the bi-directional communications between base station 112 and remote 110 at wavelengths in the infrared frequency range.

Remote 110 is not limited to any particular type of device. In various embodiments, remote 110 is any device operable to receive the beacon signal transmitted from base station 112, and to establish bi-directional communications with the base station 112 based on information included in the beacon signal. In various embodiments, remote 110 is a battery powered device, and thus is portable and moveable relative to base station 112. In various embodiments, remote 110 is a hand held device that can be carried by a user, for example but not limited to a user being a teacher in a classroom, the classroom including base station 112. In various embodiments, remote 110 includes a microphone 111 coupled to remote 110. In various embodiments, microphone 111 is a small portable type microphone that may be attached to clothing worn by the user of remote 110 so that as the user speaks, microphone 111 receives the voice of the user, and converts the voice to a signal coupled to remote 110. In various embodiments, the signal representative of the voice is transmitted to base station 112, and in various embodiments is coupled to amplifier 120 and output to one or more output devices, such as speakers 150.

In various embodiments, remote 110 includes one or more input devices 115. Input devices 115 are not limited to any particular type of devices, and can include any type of device that provides an input to remote 110. In various embodiments, input devices 115 include pushbuttons. In various embodiments, input devices 115 include a scroll wheel or a computer mouse that is operable to be manipulated by a user to provide an input signal to remote 110. In various embodiments, input devices 115 include a touch pad or touch screen operable to allow a user to touch or otherwise manipulate the touch pad or touch screen to provide inputs to remote 110. In various embodiments, inputs to remote 110 are transmitted to base station 112 and are used as control signals to control one or more of the devices in communication system 100.

In various embodiments, remote 110 includes one or more output devices 113. Output devices 113 are not limed to any particular type of output device. In various embodiments, output devices 113 include a display. The display is not limited to any particular type of display, and can be a light emitting diode display, a liquid plasma display, or any other type of display operable to provide visually displayed information. In various embodiments, output devices 113 include a device, such as but not limited to a speaker, operable to provide an audio output. In various embodiments, output device 113 includes indication lights, such as but not limited to light emitting diodes, operable to provide visual indications to a user.

In would be understood that remote 110 is not limited to any particular number or combinations of input devices 112 and output devices 113, and can include one or more devices that function as both input and output devices. By way of illustration, remote 110 can include a touch screen that allows a user to manipulate a graphical symbol, such as but not limited to a cursor on the touch screen to provide an input signal, and the same display can provide an indication, such as number or a bar graph, indicating the present setting of the parameter manipulated by the touch screen input. In various embodiments, the parameter being manipulated by an input device 112 is a volume setting associated with a user's voice being received at microphone 111 and coupled through communication system 100 to an output device, such as but not limited to speakers 150 in system 100.

In various embodiments, communication system 100 includes a plurality of remotes, represented by dotted line 117 and remote 119. The number of remotes in communication system 100 is not limited to a particular number of remotes. The types of remotes in communication system 100 is not limited to any particular types of remotes, and is not limited to each of the remotes in communication system 100 being the same type of remotes. In various embodiments, remotes 117 through 119 include any or all of the features described herein with respect to remote 110.

In various embodiments where remote 110 is battery operated, communication system 100 includes charger 116. Charger 116 is not limited to any particular type of charger, and includes any type of charger operable to recharge the battery or batteries used in remote 110. In various embodiments, charger 116 is powered from a power source 170 through power lines 172 and power output 174. In various embodiments, power source 170 is the commercial power source provided to a building or structure in which communication system 100 is installed. In various embodiments, power source 170 provides electrical power at a nominal 120 volts alternating current as is typically provided in a residential, school, or commercial building in the United States. In various embodiments, charger 116 operates at a nominal voltage provided in a area where communication system 100 is installed outside the United States, such as but not limited to one or more countries in Europe.

In various embodiments, base station 112 is operable to receive power from and to operate using power supplied from output 174. In various embodiments, amplifier 120 is operable to receive power from and to operate using a power supplied from output 174. In various embodiments, output 174 is operable to provide power at a low voltage level. In some embodiments, the low voltage level is direct current (DC) power. In some embodiments, a low voltage level includes a voltage level of 42 (Underwriters Laboratory U.L. standard) volts or less. In some embodiments, a low voltage level includes a voltage level of approximately 12 volts.

In various embodiments, the communication system in room 101B can include any combination of the embodiments and the features described herein, including the embodiments and features as described herein with respect to the communication systems described for room 101A. While the detailed description focuses on the communication system of room 101A, it would be understood that a plurality of such systems, including various combinations of the embodiments described and contemplated by the detailed description herein, could be included in communication system 100.

In various embodiments, communication system 100 includes one or more desk units 102A, 102B, 102C, through 102N. The phrase “desk unit” as used herein includes any device or apparatus that is communicatively coupleable to communication system 100 and is operable to perform any one or any combination of the functions described herein. In various embodiments, a desk unit is built into, or is otherwise physically attached to, a desk or other furnishing. In various embodiments, a desk unit refers to a portable device that is not attached to a desk or to any other furnishing. In various embodiments, a desk unit is a hand held electronic device. The number of desk units in room 101A is not limited to any particular number of desk units, and can represent any number of desk units, as represented by dotted line 102D, including a single desk unit.

In various embodiments, desk units 102A-N are operable to be registered within communication system 100. Registration includes any form of identification used to indicated which particular desk units 102A-N are to be communicatively coupled to communication system 100. By way of illustration, each desk unit 102A-N can be assigned an identification number that uniquely identifies a given desk unit from all other available desk units. In various embodiments, this unique identification number is a serial number, such as a Media Access Control (MAC) number, that is uniquely assigned to the desk unit at the time the desk unit was manufactured.

In various embodiments, each desk unit 102A-N is operable to transfer its unique identification number to the communication system 100 in order to become registered with the communication system. In various embodiments, the registration numbers for desk units 102A-N can be manually entered into the communication system, for example using computer 122. In various embodiments, desk units 102A-N are operable to transmit their unique identification numbers to a wireless receiver 121. In various embodiments, wireless receiver 121 is coupled to a communication port 123 on computer 122, wherein the received identification numbers are communicated through wireless receiver 121 and communication port 123 to computer 122 for registration. In various embodiments, communication port 123 is a standard Universal Serial Bus (USB) port, and wireless receiver 121 is a radio frequency transceiver operable to receive a radio frequency transmissions from any of the desk units 102A-N, wherein the transmissions from the desk units include the identification number of the desk unit providing the transmission.

In various embodiments, each of the desk units registered at computer 122 are registered to a particular master control unit, such as base station 112. In various embodiments, desk units registered with a particular master control unit are then assigned to use radio frequency communions at an particular radio frequency channel, wherein other master control units, for example another maser control unit located in room 101B, will assign desk units registered with the another master control unit to use a different radio frequency channel. In that way, interference will be minimized or eliminated between desk units operating in proximity to one and other but registered with different master control units, while allowing one or a plurality of the desk unit to communicate with a common master control unit to which the one or the plurality of desk units are registered.

In various embodiments, transmissions from a given desk unit include the desk unit's unique identification number, so that any master control unit receiving a transmission for a particular desk unit can use the unique identification number to determine which of the desk units the transmission has come from. In various embodiments, communications sent from the master control unit to any of the registered desk units also includes an identification number that uniquely identifies the desk unit to which the communication is being directed, wherein the desk units are operable to ignore communications except those the include the particular desk unit's unique identification number. In various embodiments, the identification number included in the communications from a master control unit to a particular desk unit is the same identification number used to register the particular desk unit with the master control unit.

In addition, in various embodiments the master control unit has access to the listing of the desk units that are registered with the master control unit. Thus, the master control unit can use the unique identification number received with any transmissions from a desk unit to verify that the transmission has come from a desk unit that is registered with the master control unit. In various embodiments, the master control unit is operable to ignore transmissions received from desk units that are not registered with the particular master control unit receiving the transmission. In that way, interfering transmissions, even if received by a first set of desk units or at the maser control unit associated with the first set of desk units from another set of desk units or from another master control unit, will be ignored by the first set of desk units or the associated master control used based on the identification numbers included in the transmissions. This feature of communication system 100 allows two or more different communication systems to operate in close proximity to one another without interference.

In various embodiments, a radio frequency used by the desk units to transmit registration requests and identification information is a low power signal, and is transmitted on a default radio frequency channel for registration, wherein the desk unit must be within a close proximity 121A to wireless device 121 to effectuate communications with the master control unit for registration. In various embodiments, close proximity 121A is a distance of approximately 10 feet or less.

In various embodiments, once a desk unit is registered, and communications between the registered desk unit and the communications system begins, a higher power level of radio frequency signal can be used for the communications between the desk unit and the communications system. In various embodiments, these higher power communication signals are transmitted on a channel that is different from the channel used to transmit the registration information, and on a channel that is different from any channels being used by other master control units operating in the vicinity of the master control unit in the room where the desk units are located, such as room 101A. The use of different channels minimizes or eliminates interference between communications between desk units and their associated maser control unit with other desk units and their different associated master control unit or units while these different communication systems operate in proximity to one and other.

In various embodiments, once the one or more desk units 102A-N are registered with the master control unit, communications between the desk units 102A-N and the master control unit can continue as further described herein.

In various embodiments, the desk units 102A-N are communicatively coupled to a base station 112, wherein communications between the desk units 102A-N and the master control unit are provided through base station 112. In various embodiments, master control unit is hardware, software, firmware, or any combination of hardware, software, and firmware that is included in base station 112, as represented by master control unit 112A. However, it master control unit 112A is not limited to being located in base station 112, and can be located in any portion of communication system 100 that is communicatively linkable to desk units 102A-N. In various embodiments, base station 112 includes the master control unit 112A operable to selectively couple any one, or a combination of the desk units 102A-N to allow the selected desk unit, or the selected desk units, to control one or more parameters associated with the devices of communication system 100.

In various embodiments, each desk unit 102A-N is communicatively coupled to the base station 112 through connections 103A-N respectively. Connections 103A-N are not limited to any particular types of connections, and can include any type of connections that are operable to allow communications of between the base station 112 and the respective desk units 102A-N. In various embodiments, connection 103A-N is operable to allow base station 112 to communicate selection and un-selection information to any one, or to any combination of, the desk units 102A-N. Selection information can include any type of communications from the base station 112 to the desk units 102A-N that indicates to a desk unit that the desk unit has been selected to control one or more parameter of the communication system 100. Un-selection information includes any type of communication from the base station 112 to a desk unit 102A-N that indicates to a desk unit that the desk unit is no longer selected to control parameters of the communication system.

Communications from the base station 112 to a desk unit 102A-N can also include a change in the particular parameter of the communication system 100 that a given desk unit is now selected to control. In various embodiments, a communications from base station 112 can include a blanket un-selection communication indicating to each of the desk units 102A-N that none of the desk units are selected to control parameters of the communication system, regardless of whether any one or any combination of the desk units were selected at the time the blanket communication was issued.

In various embodiments, any given one, or any combination of desk units 102A-N can be communicatively coupled to base station 112 using a wireless connection, illustratively represented by connections 104A-N. Wireless connections 104A-N are not limited to any particular type or types of wireless connection, and can be any type or types of wireless connections operable to communicatively couple any combination of desk units 104A-N to base station 112. By way of illustration, one or more of connections 104A-N can include a Wi-Fi type wireless connection technology, or a wireless Personal Area Network (PAN) technology.

Desk unit 102A is now discussed in more detail. However, it would be understood that the description of desk unit 102A is applicable to any combination of desk units 102B-N. In various embodiments, desk unit 102A includes a transmitter/receiver unit 105A. Transmitter/receiver unit 105A is not limited to any particular type of transmitter/receiver unit, and can include any type of unit operable to provide any of the communications to and from the desk units as described herein, including performing the operations using any communications represented by connection 103A and wireless connection 104A. In various embodiments, transmitter/receiver 105A is operable to receive a selection signal from base station 112 indicating that the desk unit 102A has been selected to control one or more parameters of communication system 100. In various embodiments, transmitter/receiver 105A is operable to receive information from base station 112 indicating which particular parameters of communication system 100 desk unit 102A has been selected to control. By way of illustration, information from base station 112 provided to desk unit 102A can include an indication that desk unit 102A has been selected to control movements of a cursor that is being displayed on display 160.

In various embodiments, desk unit 102A includes and input/output unit 106A and one or more input devices 107A. In various embodiments, input/output unit 106A is any combination of hardware and software operable to receive input signals or input data, or both, from input devices 107A, and to provide these input signals, input data, or both, to the transmitter/receiver 105 for communication to base station 112. By way of illustration, desk unit 102A includes a computer mouse 107A coupled to the input/output unit 106A, wherein the computer mouse 107A provides inputs to the input/output unit 106A. In some embodiments, when desk unit 102A is selected, these inputs are processed by the input/output unit 106A into one or more formats that are then communicated to the transmitter/receiver unit 105A. Transmitter/receiver unit 105A is operable to transmit the inputs, including any formatted inputs, to base station 112, wherein base station 112 is operable to provide the inputs to the communication system 100 for use in controlling one or more parameters of communication system 100. By way of illustration, the inputs from computer mouse 107A can be communicated to communication system 100 in order to allow the inputs from a computer mouse included in devices 107A to control the position of a cursor being displayed on display 160.

Input device 107A is not limited to any particular type of input device, and can include any type of device operable to provide inputs to communication system 100, including but not limited to computer mouse devices, standard keyboards, custom keypads, touch screens, and touch pads. In various embodiments, input device 107A is a device or unit that is built into desk unit 102A. By way of illustration, input device 107A can be a touch screen that is built into the a surface 109 of desk unit 102A.

In various embodiments, desk unit 102A includes an output unit 108A. Output unit 108A is not limited to any particular type of output unit, and can include any type of unit operable to provide output, including visual, audio, or a combination of visual and audio outputs. In various embodiments, output unit 108A is a visual indicator, such as an incandescent lamp or a Light Emitting Diode (LED) operable to provide a visual indication by being either turned on or off. In various embodiments, output device 108A is turned on to indicate that desk unit 102A has been selected to control one or more parameters of commutation system 100, and is turned off when desk unit 102A is not selected to control one or more parameters of communication system 100. In various embodiments, the visual indication provided by output device 108A is visible to a person occupying the area associated with desk unit 102A, for example, a person seated at desk unit 102A. In various embodiments, the visual indication provided by output device 108A is viewable from an area where a persons operating remote 110 can be located so that a person having remote 110 and using remote 110 to communicate selections and un-selections of desk units to base station 112 is provided a visual indication by output device 108A that desk unit 102A has been successfully selected or successfully un-selected.

In various embodiments, output device 108A includes a visual display, such as a computer screen, that is operable to provide a display viewable by an occupant in the area of desk 102A. By way of illustration, output device 108A includes a computer screen operable to display the same display that is being provided on display 160 of communication system 100. In various embodiments, the computer screen is operable whether or not desk unit 102A has been selected to provide inputs to communication system 100. Such a display can be valuable, for example, to provide for persons with special needs related to vision, where the display at desk unit 102A can provide larger text, or different colors enhanced for better viewability, for aiding the person occupying the area near the desk unit 102A where the output unit 108A is located.

In various embodiments, remote 110 is communicatively coupled to base station 112 and includes a selector 119 operable to allow inputs to be made at remote 110 that can be communicated to base station 112. In various embodiment, the inputs to selector 119 are operable to allow a user to provide selection and un-selection choices regarding desk units 102A-N to base stations 112. These choices are then used to select or un-select one or more of the desk units 102A-N. In various embodiments, once selected, the selected desk unit communicates directly with other devices of communication system 100 through transmissions to and from base station 112 in order to provide inputs for controlling one or more of the parameters of the communication system 100. In various embodiments, these communications with base station 112 are represented by arrow 190 in FIG. 1A.

The type of inputs provided by input devices 107A is not limited to any particular type of input, and can include, by way of illustration, a microphone for receiving audio inputs, such as a voice of a person occupying the area associated with desk unit 102A.

In operation, a master control unit is used to control operations associated with communications system 100, including any of the devices such as base station 112, amplifier 120, computer 122, camera 126, DVD 124, controller 130, projector 132, speakers 150, and display 160 that are included in communication system 100. Desk units 102A-N are registered with the master control unit in room 101A, for example, though a transmission in some embodiments between the individual desk units and the wireless receiver 121. Once registered, communications between the desk units 102A-N and the master control unit can be performed using, by way of illustration, the individual transmitter/receiver units 105A-N on each of the desk units 102A-N and the base station 112.

In various embodiments, a selection mechanism, such as selector 119, is used to control the selection and un-selection of one or more of the desk units 102A-N. In various embodiments, selection and un-selection information generated through the use of selector 119 is input using remote 110, and is transmitted from remote 110 to base station 112, and is then processed, formatted, and if determined to be appropriate, is transmitted to the desk units 102A-N. The transmissions to the desk units 102A-N include the identification information used to uniquely identify the particular desk unit or desk units for which the transmitted information is intended for.

In various embodiments, selector 119 includes one or more buttons. Inputs made using selector 119, such as but not limited to an actuation of button of selector 119, are used to select one or more desk units 102A-N. Upon, being selected, the one or more desk units 102A-N are operable to provide inputs through the respective input devices 107A-N located at the selected desk units 102A-N to control one or more parameters of communication system 100 according to the selection control information provided to the desk units 102A-N as part of the selection. In various embodiments, the selection includes a default selection information, wherein the selection of a desk unit provides a pre-determined type of control to the selected desk unit. By way of illustration, selection of a desk unit provides a predetermined type of control, wherein the selected desk unit is operable to provide inputs to control a cursor being displayed on display 160 of the communication system 100. In various embodiments, selection of a desk unit includes providing the desk unit with control information that indicates specifically what parameters of the communication system the selected desk unit will have control over.

In various embodiments, one or more of transmitter/receivers 105A-N are operable to detect and to receive a light signal, including but not limited to a light signal that includes wavelengths of light in the visible light range, or wavelengths of light in an infrared range. In various embodiments, the received signal includes information regarding the selection and un-selection of at least one desk unit. In various embodiments, remote 110 is operable to generate and to transmit the light signal in a narrowly focused beam that can be directed to individual transmitter/receivers 105A-N so that when the light signal is detected at the transmitter/receiver 105A-N, the desk unit uses the light signal as an indication of selection or un-selection of the desk unit receiving the light signal. In various embodiments, the light signal includes a low power laser, such as the type of laser used in hand-held pointers such as pointed intended for use in presentation to highlight portions of a displayed image on a screen using the light beam provided by the pointer.

By way of illustration, the remote 110 is aimed in the direction of a desk unit, for example desk unit 105A, and in particular at the a detector portion of the transmitter/receiver 105A operable to sense the light signal. While the remote 110 is aimed at the detector, and some actuation of remote 110 is made causing the remote 110 to transmit the light signal. Because of the narrow beam used in transient the light signal, only the detector at desk unit 105A receives the light signal. When detected, at transmitter/receiver 105A, desk unit determines from the light signal a status with regards to whether desk unit 105A is selected or unselected. In some embodiments, this can be as simply as toggling to the state opposite the desk unit's current state, for example from “selected” to un-selected” if already selected, or from “un-selected” to “selected” in i the un-selected state when the light signal is detected. In this way, no information needs to be included in the light signal as the detection of the light signal itself. In some embodiments, the initial detection of the light signal triggers the change in state. In various embodiments, data can be modulated onto the light signal in order to convey additional information to a desk unit receives the light signal, such as data related to the particular parameters of a communication system a desk unit is selected to control.

FIG. 1B illustrates a diagram 170 of a selection table 172 according to various embodiments. In various embodiments, selection table 172 is viewable on the remote device, such as remote 110 in FIG. 1A, that is being used by a teacher to select and un-select desk units. In various embodiments, selection table 172 is projected onto, or is displayed on, a display that is viewable throughout a classroom, such as the display 160 shown in FIG. 1A.

Referring again to FIG. 1B, selection table 172 includes a first column 174 and a second column 176. First column 174 includes a listing of registered desk units 175 represented as unit 1, unit 2, unit 3, unit 4, through unit N. In various embodiments, each of the units listed in column 174 are desk units that are registered to a particular master control unit associated with the selection table 172. In various embodiments, the units listed in column 174 are the desk units 102A-N as shown in FIG. 1A.

Referring again to FIG. 1B, second column 176 includes a listing of status blocks 177, wherein a given one of the status blocks 177 is associated with a given one of the units listed in column 174. Status blocks 177 include a indication of the status of the corresponding unit. Status indications are not limited to any particular type of indication, and can include text, colors, or a graphic symbols used to represent a particular status associated with the corresponding unit. By way of illustration, status block 177A indicates a status of “SELECTED” corresponding to “UNIT 1” of column 174. In various embodiments, a status of “SELECTED” indicates that the desk unit represented by “UNIT 1” has been selected to control one or more parameters of the communication system to which the desk unit is registered. In another illustration, status block 177B indicates a status of “LINKED” corresponding to “UNIT 2” in column 174. In various embodiments, a status of “LINKED” indicates that the desk unit represented by “UNIT 2” is communicatively linked to the communication system to which the desk unit is registered. In various embodiments, a communicatively linked desk unit includes a desk unit that is recognized by a master control unit as a registered desk unit, and wherein bi-directional communications are established between the desk unit and the master communication unit associated with the same master control unit in which the desk unit is registered. Other status indications, such as “OFF” when a desk unit is registered with the communication system but is not turned on, can be used to represent a status of a given desk unit.

In various embodiments, the master control unit is operable to allow highlighting of one or more of the units listed in column 174, as represented by dotted rectangle 175A. Upon highlighting a particular unit in column 174, the mastered control unit is operable to allow a change of status for the highlighted desk unit. By way of illustration, selection of a particular unit can enable a scrollable menu 178 of status choices to be viewed in the status column 176 for the particular unit, and a selection of the desired status for the particular unit can be made using one or more inputs provided by a selection mechanism to the master control unit. Once a status is chosen, the communication system is operable to impart the chosen status to the highlighted unit, including communicating to the desk unit associated with the highlighted unit a newly chosen status for the desk unit.

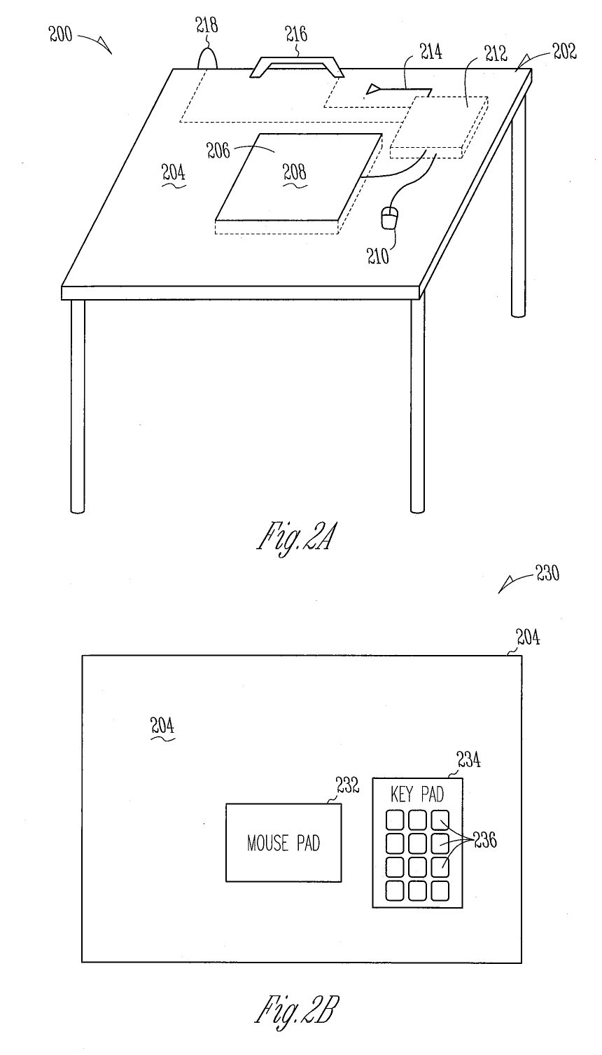

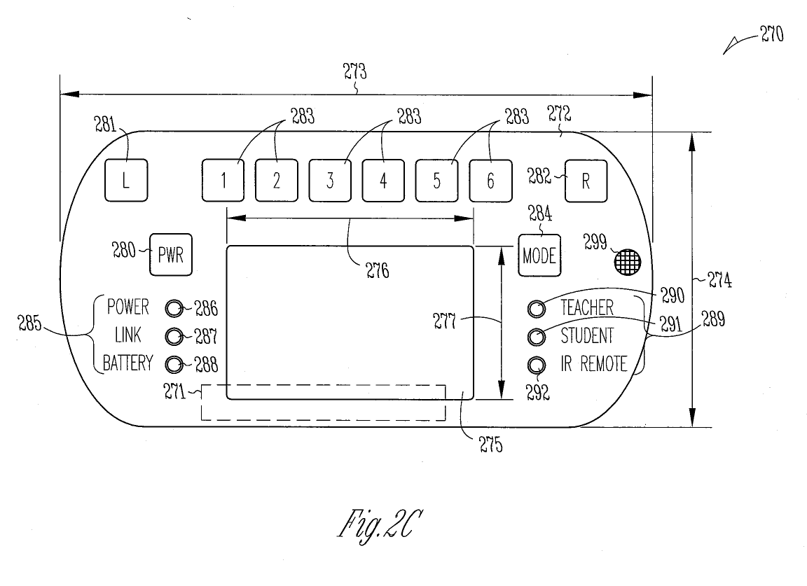

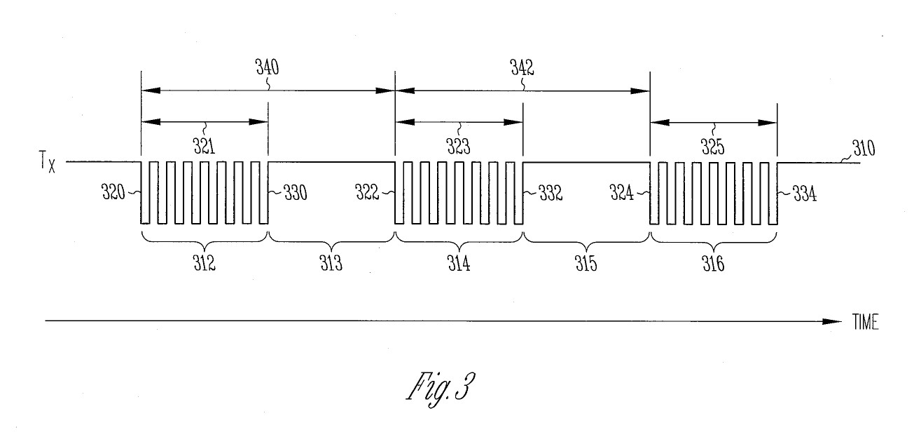

FIG. 2A illustrates a diagram 200 of a desk 202 having a built in desk unit 212 according to various embodiments. In various embodiments, desk unit 212 is mechanically mounted to desk 202 so that desk unit 212 is underneath a top surface 204 of desk 202. In various embodiments, desk unit 212 is coupled to an antenna 214, wherein antenna 214 is operable to provide wireless communications between desk unit 212 and a communication system, such as communication system 100 of FIG. 1A. Antenna 214 is not limited to any particular type of antenna, and includes any type of antenna operable to allow wireless communications between desk unit 212 and a communication system.

In various embodiments, desk 202 includes a built-in pad area 206. In various embodiments, pad area 206 is a touch screen operable to allow a user to provide inputs including “click” inputs of touches to the pad area 206, or movement inputs represented by a user moving an object, such as a user's finger or a stylus, over the surface 208 of pad area 206. In various embodiments, surface 208 is approximately flush with surface 204 of desk 202. In various embodiments, desk unit 212 is coupled to a computer mouse 210, and is operable to receive electronic signals from computer mouse 210 representing movements of the computer mouse 210, or inputs from pushbuttons actuated on the computer mouse 210.

In various embodiments, desk unit 212 is operable to process inputs, such as the inputs from pad area 206 or computer mouse 210, or both, and to communicate data representative of the inputs to a communication system. In various embodiments, the desk unit 212 is operable to transmit data associated with the inputs using antenna 214. In various embodiments, desk unit 212 is hard-wired to the communication system through some type of physical connection (not shown in FIG. 2A) and is operable to provide the data through the physical connection.

In various embodiments, desk unit 212 is operable to provide the data related to the input signals only when selected to do so. In various embodiments, desk 202 includes a visual indicator 216 coupled to desk unit 212, the visual indicator 216 operable to provide a visual indication when desk unit 212 is selected to provide inputs to the communication system that are intended to control one or more of the parameters of the communication system. Visual indicator 216 is not limited to any particular types of visual indicator, and in various embodiments includes an incandescent lamp or a Light Emitting Diode (LED) operable to illuminate when the desk unit 212 is selected.

In various embodiments, desk unit 212 receives selection and un-selection information from the communication system through antenna 214, or in some embodiments through the physical connection coupling desk unit 212 to the communication system. In various embodiments, desk 202 includes a light detector 218 coupled to the desk unit 212. In various embodiments, light detector 218 is operable to detect a light signal generated and transmitted from some other device in the communication system, such as but not limited to a remote, wherein the light signal is used to control and to provide information with respect to selection and un-selection of desk unit 212.

In various embodiments, desk unit 212 is any of the desk units 102A-N as shown in FIG. 1A.

FIG. 2B illustrates a pad area 230 according to various embodiments. In various embodiments, pad area 230 is the pad area 206 of FIG. 2A. In various embodiments, pad area 230 include one more input devices coupled to a desk unit. In various embodiment's pad area 230 is mounted on a surface, such as surface 204 as shown in FIG. 2A. In various embodiments, pad area 230 includes a mouse pad 232. In various embodiments, mouse pad 232 includes any type of device operable to detect contact or movements across the mouse pad 232, and to provide electrical output signals associated with the contact or movements.

In various embodiments, pad area 230 includes a keypad 234 including one or more keys 236. Keys 236 are not limited to any particular types of keys, and can include any combination of mechanical pushbutton or touch sensitive non-mechanical keys, or both. In various embodiments, actuation of keys 236 produce electrical signals that are provided to a desk unit. In various embodiments, inputs generated by the devices included in pad area 230 are communicated from a desk unit coupled to keypad area 230 to a communication system as inputs intended to control one or more parameters of a communication system.

FIG. 2C illustrates a desk unit 270 according to various embodiments. In various embodiments, desk unit 270 is a portable device that is powered by an internal battery 271. The device is portable in that it is not physically coupled to a desk or other furnishing, and can be picked up and carried for use at a desk for example by a student, or can be carried by a teacher moving about a classroom. In various embodiments, desk unit 270 has a length 273 and a width 274. The length 273 and the width 274 are not limited to any particular values. In various embodiments, length 273 has a value between approximately 6 and 9 inches, and width 274 has a value of between approximately 3 and 6 inches.

In various embodiments, desk unit 270 includes any combination of an area 275, buttons 280, 281, 282, and 283, and 284, and indicators 285 and 289. In various embodiments, area 275 includes a display screen operable to display video information. In various embodiments, the display screen is operable in certain modes to visually provide information related to inputs from other desk units. By way of illustration, in some embodiments the display screen is operable to display a histogram or other data diagrams based on data received as inputs from one or more other desk units coupled to a same master control unit as desk unit 270. In various embodiments, the display screen 275 is a touch screen operable to allow actuation of buttons or other graphics provided on the screen in order to provide input signals to desk unit 270. In various embodiments, area 275 includes a computer mouse pad that is operable to allow inputs, such as “clicks,” or movement inputs through a user's touching and movements at area 275, for example using a finger or a stylus on area 275 that includes the computer mouse pad.

In various embodiments, desk unit 270 includes one or more buttons 280, 281, 282, 283, and 284. The number and arrangement of the buttons in not limited to any particular number or arrangement. The type of button is not limited to any particular type of buttons, and can include mechanical buttons that are physically pressed to actuate the button, or can include non-mechanical buttons that are actuated by touching a button without the need to physically move some portion of the button or a combination of both. In various embodiments, buttons 280, 281, 282, 283, and 284, when actuated, provide input signals to desk unit 270. In various embodiments, the actuation of one or more of the particular ones of buttons 280, 281, 282, 283 and 284 has a different meaning depending on the mode that desk unit 270 is operating in at the time of the actuation.

In various embodiments, button 280 can be actuated to turn desk unit 270 “ON” and “OFF.” In various embodiments, when desk unit 270 is powered to “ON,” indicator 286 illuminates to indicate the “ON” status, and indicator 286 is not illuminated when the desk unit 270 is powered to an “OFF” state. In various embodiments, an “OFF” state does not necessarily mean that the desk unit 270 is completely powered down, and in an “OFF” state desk unit 270 can remain powered to provide certain functions, such as a desk unit security feature described herein.

In various embodiments, indicator 288 is illuminated to indicate a status for the battery 271 in desk unit 270. In various embodiments, indicator 288 is illuminated to indicate that a battery low or a battery fault condition exists, and is not illuminated when the battery 271 is operating properly or is not in a battery low condition. In various embodiments, when desk unit 270 is “ON,” and has established communications with a master control unit, indicator 287 is illuminated to indicate that desk unit 270 is “linked” to the master control unit. In various embodiments, a desk unit is considered to be “linked” to a master control unit when the desk unit is registered with the master control unit, and has established communications with the master control unit. In various embodiments, establishing communications with the master control unit includes desk unit 270 transmitting a message indicating that desk unit 270 is powered “ON,” and receiving at the desk unit 270 a confirmation signal from the master control unit indicating that the master control unit recognized the desk unit 270 as a registered desk unit and as a powered “ON” desk unit.

In various embodiments, button 284 is operable to allow programming of the desk unit 270 into one or more modes. In various embodiments, desk unit 270 is configurable to operate in either a “STUDENT” mode or in a “TEACHER” mode. In various embodiments, indicator 290 is operable to illuminate when desk unit 270 is in “TEACHER” mode, and indicator 291 is operable to illuminate when desk unit 270 is in “STUDENT” mode. In various embodiments, a first mode, for example “STUDENT” mode, is a default mode for desk unit 270. In various embodiments, in order to change desk unit 270 to “TEACHER” mode, the mode button 284 is actuated in conjunction with some other operation, such as entry of a password. In various embodiments, buttons such as but not limited to buttons 283 can be used to enter a password as part of the process for changing a desk unit 270 from a “STUDENT” mode to a “TEACHER” mode. In various embodiments, a desk unit 270 is configured when manufactured to be a unit that includes the “TEACHER” mode, wherein other particular desk units, such as desk unit 270, are not configured as a “TEACHER” unit, and can only operate in “STUDENT” mode regardless of whether the mode button on these “STUDENT” units is actuated. In various embodiment, a unit configured as a “TEACHER” unit can be distinguished by using a different color case, or by some other indication, such as a label on the desk unit itself that indicates that this particular desk unit 270 is configured to be a “TEACHER” unit.

In various embodiments, when desk unit 270 is in “STUDENT” mode, one or more of buttons 281, 282, and 283, or area 275, or both are operable to allow a user to actuate these devices in order to provide inputs to desk unit 270. In various embodiments, desk unit 270 includes a transmitter (not shown in FIG. 2C) operable to process the inputs provided to desk unit 270, and transmit data related to the inputs to the master control unit to which the desk unit is linked. In this manner, desk unit 270 is operable to provide inputs intended to control one or more parameters of a communication system coupled to the master control unit.

By way of illustration, area 275 can include a mouse pad operable to allow inputs associated with movement of, for example a finger or a stylus, on area 275. These inputs can be processed and transmitted to a master control unit in order to control the movement of a cursor being displayed at some device of the communication system. In another illustration, a question posed in a classroom can be answered through actuation of, for example, one of buttons 283, wherein the question includes a set of multiple choice answers that are numbers to correspond to the numbers included on buttons 283. In various embodiments, the inputs from buttons 283 are processed and transmitted by desk unit 270 to the master control unit that desk unit 270 is linked with. These inputs can be used to determine if the user of desk unit 270 supplied a correct answer choice to the multiple choice questions based on the inputs received from desk unit 270.

In various embodiments, desk unit 270 is selectively coupled to be operable to transmit data related to inputs at desk unit 270 to a master control unit for use in controlling parameters of a communication system coupled to the master control unit, and to be un-selected so that desk unit 270 is no longer enabled to have inputs made at desk unit 270 used to control the parameters of the communication system coupled to the maters control unit.

In various embodiments, a plurality of desk units including desk unit 270 are each selected so as to be operable to provide inputs to a master control unit during a same time period. By way of illustration, when a question is posed to a group of students in a room having each student using a separate and registered desk unit, each student can answer the posed question by actuating an input or inputs at their particular desk unit, wherein each of the desk units transmits the data received as the input to the master control unit. In various embodiments, each transmission includes a identification, such as a number, that uniquely identifies the inputs with the particular desk unit from which the input was transmitted.

In this way, the master control unit can receive data from a plurality of the selected desk units, and can determine which, if any, of the students correctly answered the posed question. In various embodiments, a desk unit operating in “TEACHER” mode can receive the input data from the master control unit. In various embodiments, a display on the desk unit operating in “TEACHER” mode, can for example in area 275, be operable to display the data received from the plurality of desk units. In various embodiments, the displayed data includes the individual inputs provided by each of one or more of the plurality of desk units responding to the posed question. In various embodiments, the data includes a summation of the inputs provided by all of the responding desk units, for example in the form of a histogram of the number of answers input for each of the possible answer choices provided to the posed question.

In various embodiments, when desk unit 270 is operating in “TEACHER” mode, desk unit 270 is operable to select, and to un-select, one or more of the desk units coupled to the same master control unit as desk unit 270, all based on inputs provided at desk unit 270. By way of illustration, when desk unit 270 is operating in “TEACHER” mode, inputs to buttons 283, or inputs to desk unit 270 made using area 275, are operable to select and to un-select one or more of any additional desk units registered with the master control unit to which the desk unit 270 is linked. In some embodiments, when the desk unit 270 is operating in “TEACHER” mode, pressing the mode button 284 changes unit to a “STUDENT” mode, wherein a “STUDENT” mode in this particular desk units makes the unit operate to select and to un-select one or more of the other desk units that are registered with the same master control unit as the desk unit 270 as the desk unit 270.

In various embodiments, desk unit 270 includes an infrared (IR) mode. In various embodiments, when in IR mode, desk unit 270 operates like a standard infrared remote. In various embodiments, in IR mode the buttons on desk unit 270 are configured to operate the same as some pre-determined standard infrared remote control. By way of illustration, when in IR mode, desk unit 270 can be configures so that actuation of buttons 283 provide a same set of controls, key by key, as some other standard infrared remote configured within the communication system. In various embodiments, buttons 283 are numbered using numbers 1 through 6, and are configured when desk unit 270 is in the IR mode to provide the duplicate functions as a keypad that is located somewhere else in the communication system, such as on a remote, or in some embodiments to duplicate the functions of a keypad of some pre-defined standard remote control, such as but not limited to any industrial or commercially standardized keypad functions for a standardized remote control.

In various embodiments, indicator 292 is illuminated when desk unit 270 is operable to monitor reception of the infrared beacon signal. Since an infrared beacon is generally a line-of-sight transmission signal, desk unit 270 will only be able to receive the infrared beacon signal when in a relative line-of-sight with respect to the base station transmitting the beacon signal. By way of illustration, the desk unit 270 can receive the infrared beacon signal when in a same room as the base station providing the infrared beacon signal. In various embodiments, if the desk unit 270 is removed so as to not receive the infrared beacon signal for some period of time, an audio alarm 299 included in desk unit 270 is operable to provide an audible alarm tone. In various embodiments, the period of time is a number of seconds, for example but not limited to 10 seconds. The audible alarm tone can be triggered, fore example, when the desk unit is taken out of the room where the infrared beacon signal is being provided.

In various embodiments, the audible alarm tone indicates that the desk unit has been removed from the room, for example; by a student who is not authorized to take the desk unit out of the room. Thus, the desk unit 270 provides a warning signal indicating that an unauthorized removal of the desk unit from a given location has occurred. This feature provides a desk unit security feature incorporated into various embodiments of the desk units 270. In various embodiments, the desk unit security feature is operable when the desk unit 270 is both “ON” and is “OFF” so that a user cannot defeat the desk unit security feature by simply turning the desk unit 270 to the “OFF” state.

In various embodiments, desk unit 272 includes a case 272 that is formed, as least in part, from a material that appears opaque with respect to wavelengths of light in the range generally visible to human beings, but is does not significantly block or diminish the strength of a transmission of light in the infrared range, when these infrared transmissions pass through case 272. In addition, the material of case 272 does not block or diminish the strength of a signal transmitted in the radio frequency range as the signal passed through case 272. By using such a material, transmissions to and from the desk unit 270 in both the infrared and the radio frequency ranges can be performed through case 272 and without the need for any external antennas on the desk unit 270. Any antennas for receiving and transmitting signals at and from desk unit 270 respectively involving infrared signals and radio frequency signals can be built into the desk unit 270 internal to case 272.

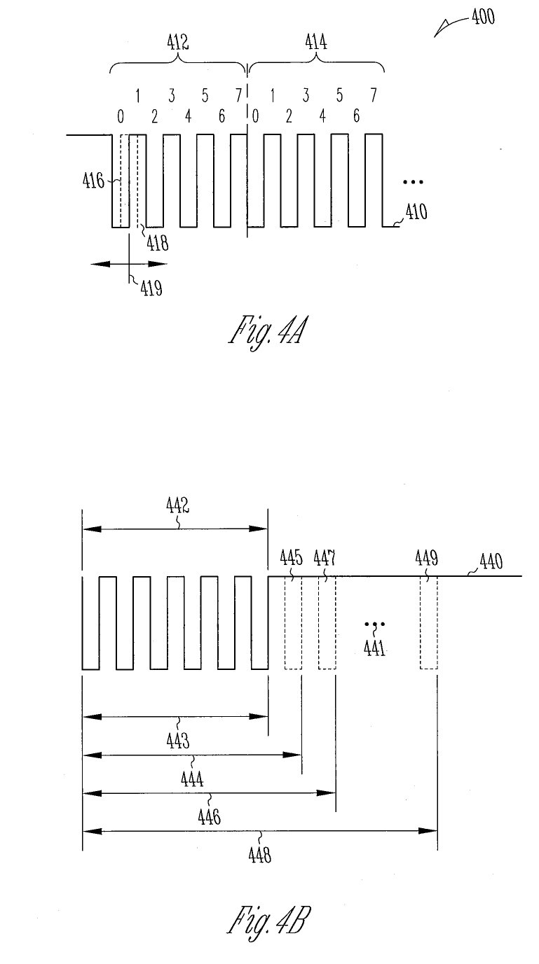

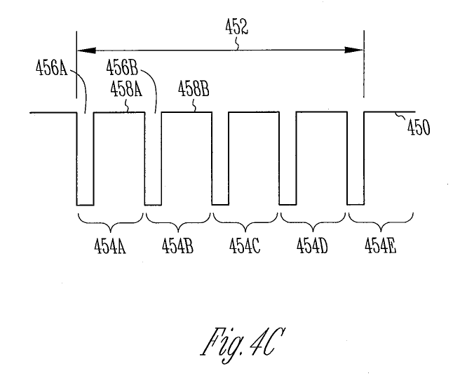

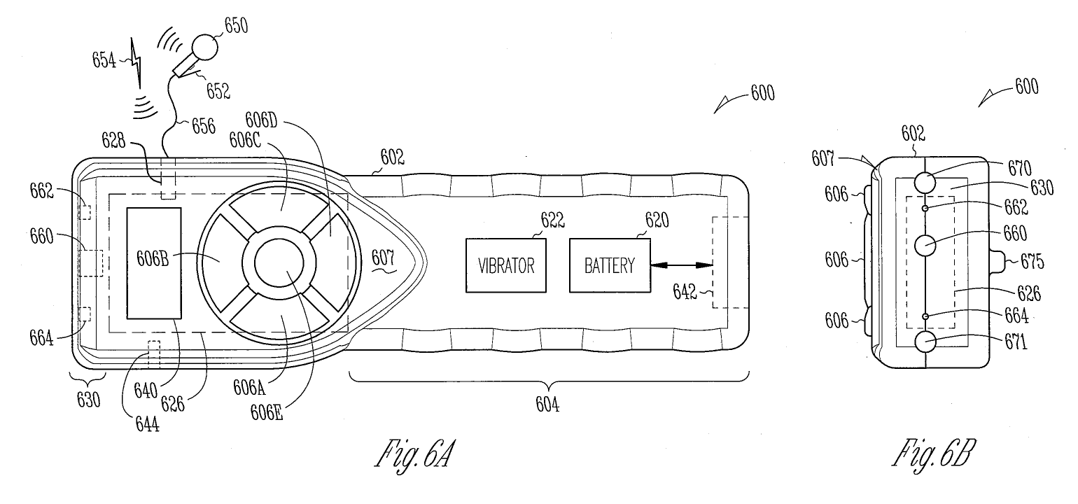

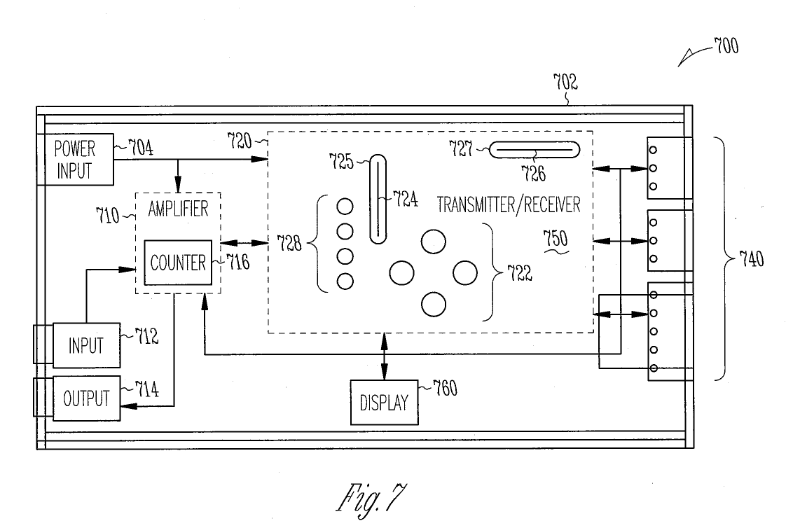

The infrared beacon signal and the material for use in case 272 are further explained herein in the description related to the waveforms of FIGS. 3, 4A-C, and 5, the remote of FIGS. 6A and 6B, and the base station of FIG. 7.

FIG. 3 illustrates a beacon signal 300 according to various embodiments. In various embodiments, beacon signal 300 is a signal generated by and transmitted from a base station, such as but not limited to base station 112 in FIG. 1A, or base station 700 in FIG. 7. In various embodiments, beacon signal 300 is a line-of-sight transmission signal as described herein. In various embodiments, beacon signal 300 includes waveform 310 including at least one information portion including an indication of a frequency or channel on which the base station providing the beacon signal 300 has selected for bi-directional communications.

In various embodiments, waveform 310 includes a plurality of pulses 312, 314, and 316 separated by time periods 313 and 315. Pulse 312 includes a leading edge 320 and a trailing edge 330 following the leading edge after time period 321. Pulse 314 includes a leading edge 322 following trailing edge 330 after time period 313. Pulse 314 includes a trailing edge 332 following the leading edge 322 after time period 323. Pulse 316 includes a leading edge 324 following the trailing edge 332 after time period 315. Pulse 316 includes a trailing edge 334 following leading edge 324 after a time period 315.

In various embodiments, during the time included within each of pulses 312, 314, and 316, waveform 310 changes between different signal levels to create a series of pulses at a given frequency. In various embodiments, the given frequency is not limited to any particular frequency, and includes any non-radio frequency used to modulate the beacon signal during each of pulses 312, 314, and 316. In various embodiments, the given frequency is an infrared frequency. In various embodiments, the given frequency is 455 kilohertz.

In various embodiments, the time interval included in time period 321 indicates information indicating the frequency or channel a base station providing waveform 310 has selected for use in its bi-directional communications. By setting the time interval included in time period 321 to different time internals depending on which frequency or channel the base station has selected of use in its bi-directional communications, a beacon signal including waveform 310 provides information related to the selected frequency or channel to a remote receiving the beacon signal including waveform 310. In various embodiments, each of pulses 312, 314, and 316 are all the same time periods 321, 323, and 325 respectively, and thus redundantly provide the same frequency or channel information within waveform 310.

In various embodiments, the time period 340 between leading edges of pulses 312 and 314 in waveform 310 represents information indicating the frequency or channel a base station providing the beacon signal 300 has selected for use in its bi-directional communications. Different time periods for time period 340 are used to represent different frequencies or channels for which a base station is operable to establish bi-directional communications. By proving a given time period for time period 340 as part of a beacon signal, a base station providing the beacon signal can indiction the frequency or channel on which the base station is operable to establish bi-directional communications. The bi-directional communications are on a different frequency or channel from the frequency on which the beacon signal is provided. By varying the time period 340 depending on the frequency or channel selected for bi-directional communications, a device such as a remote can measure time period 340, and determine a frequency or channel the base station has selected and is operable to use for performing bi-directional communications. In various embodiments, the next successive time period 342 between leading edges 322 and 324 includes a same time period as time period 340, and can be used as a redundant check of the time period measured for time period 340. In various embodiments, waveform 310 includes a continuous stream of subsequent pulses having leading edges at a time period approximately equal to time period 340. In various embodiments, leading edges for a given pulse 312, 314, and 316 are determined by having a minimum time, such as time period 313 before leading edge 322, during which the state or level of waveform 310 is unchanging.

In various embodiments, the frequency or channel information provided by time period 340 is redundant to the frequency or channel information provided within any of pulses 312, 314, and 316 by time periods 321, 323, and 325 respectively. In various embodiments, the frequency or channel information provided by time period 340 is a different frequency or channel that is indicated by the information within any of pulses 312, 314, and 316 and time periods 321, 323, and 325.

In various embodiments, the time periods 321, 323, and 325 for any one of pulses 312, 314, and 316 respectively is a fraction of the time periods 313 and 315 between these pulses, and so the time line in FIG. 3 is not evenly scaled along the length of the time line. Time periods 321, 323, and 325 are not limited to any particular time intervals. In various embodiments, time periods 321, 323, and 325 are approximately 125 microseconds. Time periods 313 and 315 are not limited to any particular time periods. In various embodiments, time periods 331 and 315 are approximately 100 microseconds. In various embodiments, the time periods for one or more of time periods 321, 323, and 325 are different time periods. In various embodiments, the time periods for 313 and 315 are different time periods.

In various embodiments, signals within a given time period 340 or 342 represent information indicating the frequency or channel selected for bi-directional communications by the base station providing the beacon signal. The format of the information within a given time period 340 or 342 is not limited to any particular format, as further illustrated with respect to FIGS. 4A-C. In various embodiments, the information within any of time periods 340 or 342 is redundant to the information included in waveform 310 related to time periods 340 and 342. In various embodiments, the information within any of time period 340 and 342 represents information related to a different frequency or channel from the frequency or channel indicated by the information including by the length of time periods 340 and 342. By using two or more different types of information to indicate more than one channel, a beacon signal may include information indicative of more than a single frequency or channel to remotes.

FIGS. 4A-4C illustrate various embodiments of waveforms 400 included within a beacon signal.

FIG. 4A includes waveform 410 including illustrative pulse sequences 412 and 414. In various embodiments, waveform 410 includes a continuous sequence of subsequent pulse sequences 412 and 414. In various embodiments, pulse sequence 412 is the same pulse sequence as pulse sequence 414. In various embodiments, pulse sequence 412 includes a plurality of data bits indicated by the individual pulses “0,” “1,” “2,” “3,” “4,” “5,” “6,” and “7” as labeled in pulse sequence 412. For each of the individual pulses within pulse 412, a duty cycle of the pulse can be varied in order to indicate a first data value or a second data value. By way of illustration, individual pulse “0” within pulse sequence 412 can have a transition at 416, or a transition at 418, as indicated by the line and arrows 419. A transition at 416 is used to indicate a first data value, and a transition at 418 is used to indicate a second data value.

By determining which of transitions 416 or 418 is included in individual pulse “0” a data value can be indicated by individual pulse “0.” By using a same variable transition scheme for all in the individual pulses within pulse sequence 412, each individual pulse can be set to indicate a particular data value, and thus the individual pulses within pulse 412 are use to represent a byte (8-bits) of data. A data byte can represent 256 different values. In various embodiments, any number of these possible values can be used to indicate information regarding a frequency or a channel selected by a base station providing waveform 410 for establishing bi-directional communications with the base station.

In various embodiments, pulse sequence 414 includes a plurality of data bits indicated by the individual pulses “0,” “1,” “2,” “3,” “4,” “5,” “6,” and “7” pulses as shown in pulse sequence 414. Like pulse sequence 412, pulse sequence 414 is used to indicate a byte of data. In various embodiments, pulse sequence 414 is the same data as in pulse sequence 412, and waveform 410 is a continuous sequence of the same pulse sequences 412 and 414. In various embodiments, pulse sequence 414 is a second data byte included in waveform 410 to be used in conjunction with pulse sequence 412 to form a 16-bit data word. In various embodiments, The 16-bit data word is repeated in a continuous pattern a number of times in waveform 410 as indicated by the dotted line 417 to the right of pulse sequence 414. In various embodiments, each individual pulse within pulse sequence 412 and 414 represent the pulses included in time interval 340 and time interval 342 in FIG. 3. It would be understood that any number of data bits could be included in the data represented by a pulse sequence such as pulse sequences 412 and 414.

Waveform 410 is not limited to any particular type of signal levels. In various embodiments, waveform 410 is digital data level signals. In various embodiments, waveform 410 is provided as any level of signals that may be used by a base station to provide frequency or channel information to remotes, such as but not limited to the base stations and remotes as shown in FIG. 1A and FIG. 7.

FIG. 4B includes waveform 440 including a sequence of pulses 442. The number of pulses in the sequence of pulses 442 is not limited to any particular number of pulses. In various embodiments, a time interval 443 between the first transition in the sequence of pulses 442 and the last transition in the sequences of pulses 442 is an indication of a frequency or a channel selected by a base station providing waveform 440 for establishing bi-directional communications with the base station. In various embodiments, waveform 440 includes the sequence of pulses 442 plus an additional pulse 445. In embodiments including the additional pulse 445, the time interval 444 between the first transition in the sequence of pulses 442 and the last transition of pulse 445 is a time interval different from time interval 443.

In various embodiments, the different time interval of 444 is used to indicate a different frequency or channel selected by a base station providing waveform 440 for establishing bi-directional communications with the base station. In various embodiments, any number of additional pulses 447 through 449, as indicate by dotted line 449, may be added to indicate providing different time intervals 446 through 448, the different time intervals indicative of different frequencies or channels selected by the base station providing waveform 440 for establishing bi-directional communications with the base station. In various embodiments, all of the pulses depicted in waveform 440 are the individual pulses included within an burst during a time interval such as but not limited to pulse 312 in FIG. 3.

Waveform 440 is not limited to any particular type of signal levels. In various embodiments, waveform 440 is digital data level signals. In various embodiments, waveform 440 is provided as any level of signals that may be used by a base station to provide frequency or channel information to remotes, such as but not limited to the base stations and remotes as shown in FIG. 1A and FIG. 7.

FIG. 4C includes waveform 450 including a sequence of pulses 454A-E. In various embodiments, waveform 450 includes a continuous sequence of subsequent pulses as illustrated by pulses 454A-E. Referring to pulse 454A, the pulse includes a first portion 456A, and a second portion 458A. The duty cycle time comparing the time of the first portion 456A and the time of the second portion 458A can be used to indicate a frequency or channel selected by the base station providing waveform 450 for establishing bi-directional communications with the base station. In various embodiments, each different duty cycle within pulse 454A indicates a different frequency or channel selected by the base station providing waveform 450. In various embodiments, each subsequent pulse 454B-E includes a same duty cycle as included in pulse 454A, and thus provides redundant information to the indication included in pulse 454A. In various embodiments, each of pulses 454A-E represents a burst and an off time as included in time interval 340 of waveform 310 in FIG. 3.

Waveform 450 is not limited to any particular type of signal levels. In various embodiments, waveform 450 is digital data level signals. In various embodiments, waveform 450 is provided as any level of signals that may be used by a base station to provide frequency or channel information to remotes, such as but not limited to the base stations and remotes as shown in FIG. 1A and FIG. 7.

It should be understood that FIGS. 4A-4C are illustrative of types of waveforms that are usable as part of beacon signals as described herein. However, embodiments of beacon signals are not limited to the types of waveforms illustrated in FIGS. 4A-4C. Embodiments, may include any type of waveforms operable to provide channel information in a beacon signal. Various embodiments may combine two or more types of signals, such as but not limited to those shown in FIGS. 4A-4C, in order to provide channeled information in a beacon signal. In various embodiments including a combination of two or more types of signals, the information may be redundantly included in each of the types of signals. Any possible combination of techniques for providing channel information may be included in the beacon signals of the various embodiments described herein.

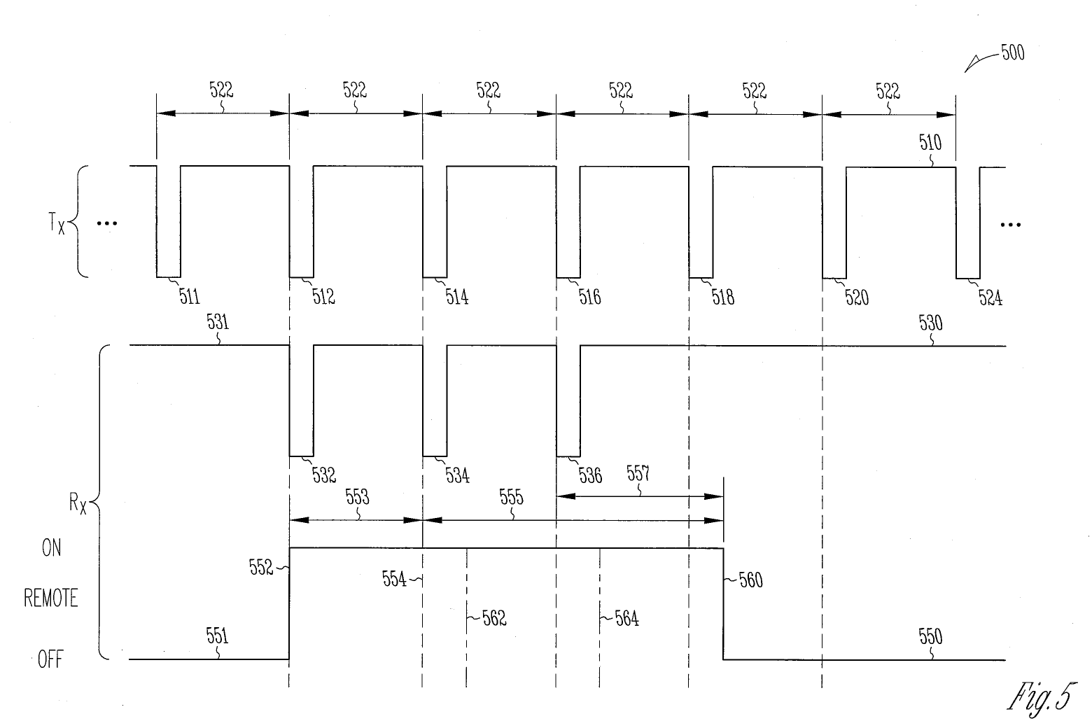

FIG. 5 illustrates waveforms 500, including waveforms 510, 530, and 550. Waveform 510 includes a waveform representative of a beacon signal that is transmitted from a base station. Waveform 510 includes pulses 511, 512, 514, 516, 518, 520, and 524 occurring at a time interval 522. Based on at least the time interval 522, a remote receiving waveform 510 is operable determine the frequency or channel on which the base station providing waveform 510 has selected and is operable to perform bi-directional communications.

Waveform 530 represents a waveform of a beacon signal as received at a remote. Waveform 530 includes pulses 532, 534, and 536. Prior to pulse 532 during time period 531, although pulse 511 is transmitted, no pulses are received at the remote, and so the remote is off as depicted by the low level of waveform 550 during time period 551. Pulse 532 in waveform 530 represents receiving a pulse 512 from a base station at the remote. At time 552, waveform 550 changes to the on level, as represent by the change of state in waveform 550 at time 552. In various embodiments, based on the time period of pulse 532, the remote receiving the beacon signal may determine the indication of the frequency or channel selected by the base station providing waveform 510 for use in bi-directional communications. In various embodiments, the remote may delay beginning bi-directional communications until at least a second and redundant indication of the selected frequency or channel has been received and confirmed.

A second pulse 534 is received at the remote as represented in waveform 530. At time 554, the remote is operable to determine the time 553 between pulses 532 and 534, and from time 553 is operable to determine the frequency or channel the base station providing waveform 510 has selected for bi-directional communications. After time 544, and once the remote has determined which frequency or channel the base station providing waveform 510 has selected for bi-directional communications, the remote can begin bi-directional communications with the base station providing waveform 510 using the determined frequency or channel.

In various embodiments, following receiving a pulse in a beacon signal, the remote will begin a watchdog timer that will time out at some time period longer than the time interval 522 between the pulses in waveform 510, but that is reset each time a pulse is received at the remote. By way of illustration, for pulse 532, the remote will begin a watchdog timer that will time out at time 562 as shown in waveform 550. However, the watchdog timer is reset by pulse 534 in waveform 530. As a result of receiving pulse 534 at the remote, the watchdog timer will again begin the watchdog timer so as to time out at time 564 as shown in waveform 550. However, the watchdog timer is again reset by pulse 536. As long as the remote's watchdog timer is reset by another received pulse, the remote will remain on, as illustrated by time period 555 in waveform 550. However, as shown in waveform 530, pulse 536 is the last pulse received at the remote, and so after time period 557, the remote's watchdog timer will have timed out, and the remote will turn off, as indicated by the transition 560 in waveform 550. In various embodiments, since the pulses in a beacon signal from a base station will only be received by a remote when the remote is within an approximate line-of sight transmission space of the base station, the reception of pulses received by a remote will occur when a remote is brought into this approximate line-of sight transmission space, and will no longer be received at the remote when the remote is removed from any approximate line-of sight transmission space of the base station. Thus, as illustrated by waveform 550, a remote can be operable to automatically turn on upon receiving a beacon signal including pulses from a base station, and can be operable to automatically turn off when the beacon signal including pulses is no longer being received at the remote. Further, upon receiving the pulses, the remote is operable to determine a frequency or a channel on which to establish bi-directional communications with the base station for which the pulses are being received.

In various embodiments, receiving or not receiving the beacon signal including pulses provides a way to automatically turn on and turn off a remote when the remote enters and leaves respectively an approximate line-of-sight transmission space of an enclosure where a base station is located and where the base station is transmitting a beacon signal.

FIGS. 6A and 6B illustrate embodiments of a remote 600. Remote 600 is not limited to any particular type of remote, and may be remote 110 and additional remotes 117 through 119 as shown in FIG. 1A.

FIG. 6A includes remote 600 having a case 602, and at least one transceiver 626. In various embodiments, remote 600 includes a handle area 604. Handle area 604 allows remote 600 to be hand held by a user. In various embodiments, case 602 includes an end area 630, wherein at least the end area 630 is formed of a transmissive material. A transmissive material is a material that is transmissive of the wavelengths of radio frequencies used by the remote to communicate with a base stations, and is also transmissive of the wavelengths of the signals provided as a beacon signal from a base station. In various embodiments, the transmissive material is composite of acrylonitrile butadiene styrene (ABS) plastic with a percentage of an infrared fill material. In various embodiments the transmissive material is a composite of acrylic plastic with a percentage of infrared fill material.

In various embodiments, transmissive material is transmissive of wavelengths of radio frequencies operating in the gigahertz range, and is also transmissive of wavelengths at infrared frequencies, including wavelengths operating at or near 870 nanometers. Transmissive material is material that does not attenuate to any significant amount the signal passing through the material.

In various embodiments, since at least end area 630 is transmissive of both the frequencies used for the beacon signals and the frequencies used for the bi-directional communications, no opening related to the transmission and reception of these signals is required in end areas 630, or in any other potion of case 602. The feature of not requiring opening reduces the cost of manufacturing the case 602.

In various embodiments, remote 600 includes one or more microphones, such as microphone 650, coupled to remote 600. In various embodiments, remote 600 includes a build-in microphone 660. In various embodiments, built-in microphone 660 is located in an end location of remote 600, as further illustrated in FIG. 6B. Referring again to FIG. 6A, in various embodiments remote 600 includes the remote microphone 650. In various embodiments, remote microphone 650 is coupled to remote 600 through a physical coupling 656. Physical coupling 656 is not limited to any particular type of physical coupling, and may include a plurality of physical conductors, or any type of transmission line operable to transmit signals between microphone 650 and remote 600. In various embodiments, power is provided to remote microphone 650 through physical connection 656. In various embodiments, remote 600 includes input 628 to couple physical connection 656 with remote 600.

In various embodiments, remote microphone 650 is coupled to remote 600 though a wireless channel 654. Wireless channel 654 is not limited to any particular type of wireless channel, and may include any type of wireless channel operable to allow remote microphone 650 to be communicatively coupled to remote 600. In various embodiments, microphone 650 is battery powered from a battery (not shown in FIG. 6A) included within remote microphone 650. In various embodiments, remote microphone 650 includes an attachment device 652 to allow the remote microphone 650 to be attached or held in an area close to a source of sound, such as but not limited to a user's voice. By way of illustration, remote microphone 650 includes a clip that would allow a user to attach remote microphone 650 to the user's clothing in the area near the user's mouth in order to allow remote microphone 650 to better receive the user's voice.

In various embodiments, the entire case 602, with the possible exceptions of one or more of actuatable devices 606A-E and output device 640, are formed of the transmissive material.

FIG. 6B illustrates an end view of remote 600, including case 602 and end area 630. Transceiver 626 is shown included within case 602 of remote 600. In various embodiments, end areas 630 does not include or require any openings in case 602 in order to allow reception and transmission of any of the signal received at and transmitted from remote 600. In various embodiments, end area 630 includes one opening 670, or a plurality of openings 670 and 671. Openings 670 and 671, if present in end area 630, provide openings for allowing a beacon signal including a sound wave to enter and be detected by remote 600.

In various embodiments, end area 630 includes built-in microphone 660 as described herein. In various embodiments, end area 630 includes one or more indicators 662 and 664. Indicators 662 and 664 are not limited to any particular type of indicator, and includes any type of indicator providing information to a user. In various embodiments, one or more of indicators 662 and 664 are light emitting diodes. In various embodiments, indicators 662 and 664 include an indiction, such as but not limited to a light emitting diode, capable of providing more than one color light indication used to represent different states. In various embodiments, at least one of indicators 662 and 664 include a battery indicator for indicating to a user the state of a battery in remote 600. In various embodiments, at least one of the indicators 662 and 664 indicate the state of the battery using a first color to indicate a battery charged to within a power operating range, and a second color to indicate a low or inoperable battery. In various embodiments, at least one of indicators 662 and 664 are used to indicate a state of the battery providing a visual indiction that a battery in remote 600 is approaching a discharged or low charge state. In various embodiments, the indication of a approaching discharge or low charge state includes a flashing on and off of at least one of indicators 662 and 664. In various embodiments, the indication of an approaching discharge or low charge state includes a particular color indication provided by at least one of indicators 662 and 664.

In various embodiments, at least one of indicators 662 and 664 include an indication of whether the remote 600 has or has not currently established bidirectional communications with a base station. In various embodiments, at least one of indicators 662 and 664 are operable to provide a visual indication of whether a beacon signal is or is not being received within the timeout period for receiving a beacon signal for the remote 600. In various embodiments, any of the indicators 662 and 664 use any of the type of indications including but not limited to visual color or flashing indications as described herein. Embodiments of remote 600 are not limited to having a particular number of indicators 662 and 664, and may include more or less indicators, including having no indicators on end area 630.

In various embodiments, one or more of indicators 662 and 664 provide an audible indication, such as but not limited to an audible sound, to indicate any of the states or a statuses associated with remote 600.

Returning to FIG. 6A, in various embodiments remote 600 includes a vibratory mechanism, such as vibrator 622, operable to provide a physical motion that can be sensed by a user holding or having close proximity to the remote, and is used to indicate information related to the state or status of remote 600. By way of illustration, vibrator 622 may provide a vibration in remote 600 to indicate to a user that the microphone or microphones coupled to remote 600 have either establish bi-directional communications with a base station, or have terminated a previously established bi-directional communications with a base station. This feature is advantageous in that a user of the remote can receive a vibration when entering into a room indicating that the remote has established bi-directional communications with a base station, and vibrations when exiting a room indicating to the user that the remote has terminated any established bi-directional communications with a base station. This information is useful to the user to assure that the user knows whether any microphone included in the remote is or is not coupled to communicate with a base station without the need to look at the remote 600. This feature is advantageous when a remote is fastened to a user in a position that is not easily viewable from the user's perspective, such as the users belt at a user's waist level, or within the user's clothing, such as a pocket of the user.

In various embodiments, remote 600 includes fastener 675 operable to allow attachment of remote 600 to a user. In various embodiments, fastener 675 is formed as part of case 602. In various embodiments, fastener 675 is formed of the transmissive material used to form end area 630, and so does not interfere with the transmissions to and from remote 600 or with the reception of signals at remote 600.

In various embodiments, remote 600 includes one or more actuatable devices 606A-E on a front surface 607. Actuatable devices 606A-E are not limited to any particular number of devices, and may includes any number of individual devices. Actuatable devices 606A-E are not limited to any particular types of devices. Actuatable devices 606A-E may include pushbuttons, mouse buttons, scroll wheels, or any other type of device that allows actuation to provide input signals to remote 600. In various embodiments, actuatable devices 606A-E include any of the devices 112 described herein with respect to FIG. 1A. In various embodiments, one or more of actuatable devices 606A-E perform more than one type of actuation function. By way of illustration, an actuation device such as but not limited to actuation device 606E operate as a mouse button for controlling an input when operated using side pressure, and may act as a pushbutton when pressed in a downward direction perpendicular to the direction of the side pressure.

In various embodiments, remote 600 includes an output device 640, such as but not limited to a display. Output device 640 is not limited to any particular type of output device, and may include any type of output device, including but not limited to the output devices 113 described herein with respect to FIG. 1A.

In various embodiments, remote 600 includes a battery 620. In various embodiments, battery 620 is located within case 602 in handle area 604. In various embodiments, battery 620 is a non-rechargeable and replaceable battery intended to operate remote 600 for a given time, and then to be replaced with a new battery. In various embodiments, battery 620 is a rechargeable battery intended to power remote 600 and to be rechargeable a number of times. In various embodiments, battery 620 is a nickel-cadmium (NiCd) battery. In various embodiments, battery 620 is a nickel metal hydride (NiMH) battery. In various embodiments, battery 620 is a lithium-ion (Li-Ion) battery.

In various embodiments, remote 600 includes one or more connections coupled to battery 620 for coupling to an electrical power source for recharging battery 620. In various embodiments, remote 600 includes a connection 642 in the end of handle areas 604 for coupling to battery 620 for recharging battery 620. In various embodiments, remote 600 includes a connection 644 in the side of remote 600 for coupling to battery 620 for recharging battery 620.

In various embodiments, battery 620 includes a battery type that is rechargeable without a coupling that requires a direct physical connection between the battery 620 through any opening in the case 602.

It would be understood that in various embodiments, battery 620 may include a plurality of batteries coupled to operate as a battery unit. In various embodiments, battery 620 is operable to provide more than one different voltage level to remote 600, or provide an output of one or more different voltage levels to power devices coupled to remote 600, including but not limited to microphone 650.

FIG. 7 illustrates a base station 700 according to various embodiments. Base station 700 is not limited to any particular type of base station. In various embodiments, base station 700 is base station 112 as shown in FIG. 1A.

Referring to FIG. 7, in various embodiments base station 700 includes a case 702 including one or more transmitters and one or more receivers represented by transmitter/receiver 720. In various embodiments, transmitter/receiver 720 includes at least one transmitter and receiver operable to communicatively couple, using bi-direction commutations, base station 700 with at least one remote (not shown in FIG. 7), such as any of the remotes 110 and 117 through 119, and 600 as shown in FIG. 1A, and FIGS. 6A and 6B respectively.

In various embodiments, transmitter/receiver 720 includes a transmitter operable to generate and to transmit a beacon signal as described herein. In various embodiments, the generated beacon signal is applied to one or more transmission devices 722. In various embodiments, transmission devices 722 are light emitting diodes operable to emit light in at a particular wavelength, or within a particular range of wavelengths. In various embodiments, transmission devices 722 are operable to emit infrared emissions having a wavelength of 870 nanometers. In various embodiments, transmission devices have a “off” portion of the duty cycle for the beacon signal that is at least one thousand times as long as the “on” portion of the duty cycle for the beacon signal. In various embodiments wherein the transmission devices 722 are light emitting diodes, a current of 1 to 3 amperes flows through each of the light emitting diodes during the some portion or portions of the “on” portion of the duty cycle for the beacon signal. The high current flow through the light emitting diodes exceeds the normal maximum limit for forward current through these diodes, but due to the fractional portion of the entire duty cycle during which the light emitting diode actually sees the forward current flow, the junction temperature of the light emitting diode is not exceeded, and therefore the light emitting diode is not damaged by these levels of forward current.

In various embodiments, transmission devices 722 are physically mounted so as to protrude through surface 750 of case 702 so that a protruding portion of transmission devices 722 can provide emissions outside case 702. In various embodiments transmission devices 722 are merely holes formed in case 702 operable to allow sound waves to be emitted from case 702. In such instances, base station 700 includes at least a transmitter included within or as part of transmitter/receiver 720 operable to provide a sound wave or waves capable of including information indicative of a frequency or a channel on which base station 700 can establish bi-directional communications.

In various embodiments, transmitter/receiver 720 is coupled to at least one antenna, such as but not limited to antenna 724. Antenna 724 is not limited to any particular type of antenna, and includes any type of antenna operable to transmit and receive the bi-directional communications from and to base station 700.

In various embodiments, antenna 724 is a dipole antenna. In various embodiments, antenna 724 is a microstrip antenna. In various embodiments, antenna 724 is a fractal antenna.

In various embodiments, antenna 724 is located within case 702, and opening 724 is provided in surface 750 of case 702 to allow the transmissions and the reception of signals to and from antenna 724. The size and shape of opening 724 is not limited to any particular size and shape, and can be any size and shape operable to minimize or eliminate any interference the case 702 might cause with the transmission and reception of signals to and from antenna 724. In various embodiments, antenna 724 is located on surface 750. In various embodiments, antenna 724 is locate outside case 702, and coupled to the transmitter/receiver 720 though some type of coupling through case 702.

In various embodiments, base station 700 includes a plurality of antenna. Base station 700 is not limited to any particular number of antennas, and may include any number of antenna determined to be desirable for use in the particular application in which base station 700 is being applied. In various embodiments, base station includes antenna 724 and antenna 726, wherein antenna 724 and antenna 726 are arranged to have a longitudinal axis perpendicular to one another. Such an arrangement of antenna with a perpendicular arrangement of longitudinal axis provides more complete coverage of an area of transmission and reception for any signals transmitted from and intended to be received base station 700. In various embodiments, antenna 726 is located within case 702, and opening 727 is provided in surface 750 of case 702 to allow the transmissions and the reception of signals to and from antenna 726. The size and shape of opening 727 is not limited to any particular size and shape, and can be any size and shape operable to minimize or eliminate any interference the case 702 might cause with the transmission and reception of signals to and from antenna 726. In various embodiments, antenna 726 is located on surface 750. In various embodiments, antenna 726 is locate outside case 702, and coupled to the transmitter/receiver 720 though some type of coupling through case 702.

In various embodiments, base station 700 includes a power input 704. Power input 704 is not limited to any particular type of input, and may include any type of connection operable to allow connection of base station 700 to a source of electrical power. In various embodiments, power input 704 is operable to couple to a source of low voltage direct current power. Low voltage direct current (DC) operation includes direct current having a voltage of 40 volts DC or less. In various embodiments, low voltage operation includes direct current having a voltage of approximately 12 volts.

In various embodiments, power input 704 is coupled to transmitter/receiver 720, and is operable to provide power to transmitter/receiver 720. In various embodiments, power input 704 is coupled to amplifier 710, and is operable to provide power to amplifier 710. Amplifier 710 is not limited to any particular type of amplifier, and may include one or more amplifiers operable to amplify any of the signals present in base station 700, including but not limited to any signals transmitted from or received by base station 700. In various embodiments, amplifier 710 is coupled to input 712. Input 712 is not limited to any particular type of input, and includes but is not limited to an input operable to receive any type of audio input signals. In various embodiments, input 712 is operable to couple video signals to amplifier 710.

In various embodiments, amplifier 716 is coupled to output 714. Output 714 is not limited to any particular type of output, and may include but is not limited to an audio output. In various embodiments, output 714 includes a video output.

In various embodiments, base station 700 includes one or a plurality of outputs 740. In various embodiments, outputs 740 includes one or a plurality of different types of outputs, including but not limited to an RS-232 compliant output, an audio signal output, and video signal output.

In various embodiments, base station 700 includes one or more indicators 728. Indicators 728 are not limited to any particular type of indicators, and may include any type of indicators operable to provide information. In various embodiments, indicators 728 are light emitting diodes. In various embodiments, indicators 728 provide information to indicate that power is present at the base station. In various embodiments, indicators 728 provide information related to any radio frequency links established with the base station. In various embodiments, indicators 728 provide information related to the beacon signal at the base station, including providing an indication as to whether or not a beacon signal is being transmitted by the base station 700. In various embodiments, indicators 728 provide information related to one or more communication ports included in base station 700.

In various embodiments, base station 700 includes a display 760. Display 760 is not limited to any particular type of display, and may include any type of display operable to display information. In various embodiments, display 760 is operable to display information related to a frequency or a channel which the base station has selected for use in establishing bi-directional communications.

In various embodiments, when a base station is first powered or is otherwise first activated, the base station first scans each of the frequencies or channels the base station is operable to establish bi-directional communications on. Scanning includes monitoring any one or more or all of the frequencies or channels to receive any communications that might be occurring on these frequencies or channels. During the scanning, the base station that is performing the scanning does not transmit any signals on any of the frequencies or channels within the range of frequencies that includes these channels. During the scanning, the base station performing the scanning will detect any received bi-directional communications being transmitted on the channels being scanned. The base station is operable to determine a frequency or a channel where there is no bi-directional communications being received at the base station, and is operable to select that frequency or that channel having no or only non-interfering levels of detected communications as the frequency or channel the base station will operate on when it establishes any bi-directional communications. Once the frequency or channel is selected, the base station will begin transmitting a beacon signal, the beacon signal to include at least one information portion including information indicating the frequency or the channel the base station has selected for bi-directional communications.

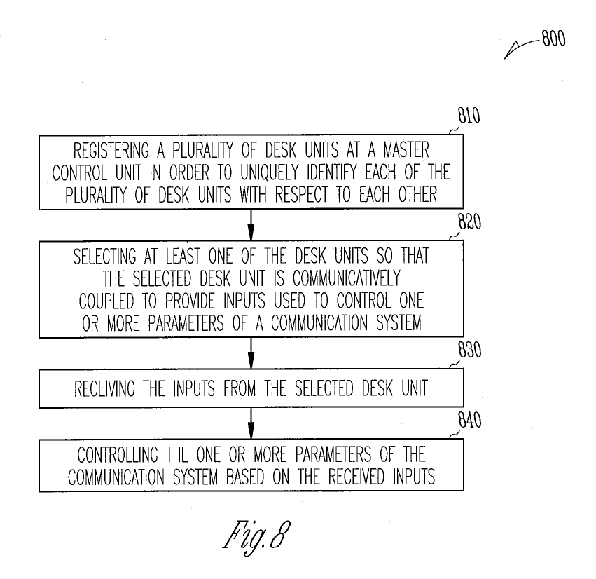

FIG. 8 illustrates a flowchart for various methods 800 according to various embodiments.

At block 810 method 800 includes registering a plurality of desk units at a master control unit in order to uniquely identify each of the plurality of desk units with respect to each other, wherein each of the desk units is selectable and un-selectable based on selection inputs to the master control unit;

At block 820 method 800 includes selecting at least one of the desk units so that the selected desk unit is communicatively coupled to provide inputs used to control one or more parameters of a communication system, wherein the one or more parameters of a communication system includes at least one output of the communication system;

At block 830 method 800 includes receiving the inputs from the selected desk unit; and

At block 840 method 800 includes controlling the one or more parameters of the communication system based on the received inputs.

Various embodiments, of an interactive desk unit have been described herein. Various embodiments include n apparatus comprising a master control unit, one or more output devices coupled to the master control unit, the one or more output devices operable to provide observable outputs in at least one room, the master control unit operable to control one or more parameters of the observable outputs, and at least one desk unit including an input device, the input device operable to generate input signals based on actuation of the input device, and to provide the input signals to the desk unit, wherein the desk unit is operable to be communicatively linkable to the master control unit, wherein the master control unit is operable to select and to un-select the desk unit so that when the desk unit is selected, the selected desk unit is operable to communicate the data related to the generated input signals to the master control unit in order to control at least one of the one or more parameters of the observable outputs.

Various embodiments, include a method of operating a communication systems, comprising registering a plurality of selectable desk units at a master control unit in order to uniquely identify each of the plurality of desk units with respect to each other, wherein each of the desk units is selectable and un-selectable based on selection inputs to the master control unit, selecting at least one of the desk units so that the selected desk unit is communicatively coupled to provide inputs used to control one or more parameters of a communication system, wherein the one or more parameters of a communication system includes at least one output of the communication system, receiving the inputs from the selected desk unit, and controlling the one or more parameters of the communication system based on the received inputs.

Various embodiments, include a communication system comprising a master control unit, one or more output devices coupled to the master control unit, the one or more output devices operable to provide observable outputs in at least one room, and the master control unit operable to control one or more parameters of the observable outputs, and a plurality of desk units communicatively coupled to the master control unit, each of the plurality of desk units registered with the master control unit and each of the desk units including at least one input device operable to provide input signals to the desk unit based on actuation of the input device, wherein the master control unit is operable to select and to un-select each of the desk units in any combination so that for any of the selected desk units, the selected desk unit is operable to provide data related to the input signals generated by the input device of the desk unit to the master control unit, the data to control at least one of the one or more parameters of the observable outputs.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims and the full range of equivalents to which such claims are entitled.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus comprising:
a master control unit;
one or more output devices coupled to the master control unit, the one or more output devices operable to provide observable outputs in at least one room, the master control unit operable to control one or more parameters of the observable outputs; and
at least one desk unit including an input device, the input device operable to generate input signals based on actuation of the input device, and to provide the input signals to the desk unit, wherein the desk unit is operable to be communicatively linkable to the master control unit;
wherein the master control unit is operable to select and to un-select the desk unit so that when the desk unit is selected, the selected desk unit is operable to communicate the data related to the generated input signals to the master control unit in order to control at least one of the one or more parameters of the observable outputs.

2. The apparatus of claim 1, wherein the desk unit is operable to be registered with the master control unit using an identification number that uniquely identifies the desk unit.

3. The apparatus of claim 1, wherein the master control unit is operable to receive a transmitted signal from the desk unit, the transmitted signal including a request that the desk unit be registered with the master control unit.

4. The apparatus of claim 3, wherein the transmitted signal from the desk unit includes an identification number that uniquely identifies the desk unit.

5. The apparatus of claim 1, wherein the desk unit is a portable device that is configurable to operate either as a student unit or as a teacher unit, and wherein only the teacher unit is operable to provide one or more selection choice inputs to the master control units, the selection choice inputs determining which of the at least one desk units are selected to provide input signals to the master control unit in order to control the at least one of the one or more parameters of the observable outputs.

6. The apparatus of claim 5, wherein the at least one unit includes a plurality of pushbuttons operable to allow activation of at least one of the plurality of pushbuttons in response to a posed question, to output and wherein the teacher unit includes a display device operable to display a summary of the results.

7. The apparatus of clam 1, wherein the at least one desk unit includes a computer mouse interface operable to receive either absolute or relative type mouse signal inputs, and to provide to the master control unit as the generated input signals an output data that is associated with the mouse signal inputs.

8. The apparatus of claim 1, wherein the desk unit includes a touch surface that is built into a top surface of a desk, wherein touch surface is in approximately a same plane as the top surface of the desk.

9. The apparatus of claim 1, wherein the master unit includes a selector that is operable to allow actuation of the selector to provide selection inputs to the master control unit, the selection inputs used to select the at least one desk unit with regards to the desk unit having control over the at least one of the one or more parameter of the observable outputs.

10. A method of operating a communication systems, comprising:
registering a plurality of selectable desk units at a master control unit in order to uniquely identify each of the plurality of desk units with respect to each other, wherein each of the desk units is selectable and un-selectable based on selection inputs to the master control unit;
selecting at least one of the desk units so that the selected desk unit is communicatively coupled to provide inputs used to control one or more parameters of a communication system, wherein the one or more parameters of a communication system includes at least one output of the communication system;
receiving the inputs from the selected desk unit; and
controlling the one or more parameters of the communication system based on the received inputs.

11. The method of claim 10, wherein the inputs used to control the one or more parameters of the communication system include data generated by the actuation of a computer mouse, wherein the data is used to control the movements of a cursor displayed on a display of the communication system.

12. The method of claim 10, wherein receiving the inputs from the selected desk units includes:
providing an observable question as part of the output of the communication system;
providing a plurality of answer choices to the observable question, each of the plurality of answer choices keyed to at least one separate input device of a set of input devices on each of the plurality of desk units;
receiving an answer generated at one or more of the desk units by the actuation of one of the separate input devices at one or more of the plurality of desk units, the answer data generated including a selection of one of the set of input devices actuated to represent an answer choice to the observable question; and
displaying as an output from the communication system a summary of the received answer data.

13. A communication system comprising:
a master control unit;
one or more output devices coupled to the master control unit, the one or more output devices operable to provide observable outputs in at least one room, and the master control unit operable to control one or more parameters of the observable outputs; and
a plurality of desk units communicatively coupled to the master control unit, each of the plurality of desk units registered with the master control unit and each of the desk units including at least one input device operable to provide input signals to the desk unit based on actuation of the input device;
wherein the master control unit is operable to select and to un-select each of the desk units in any combination so that for any of the selected desk units, the selected desk unit is operable to provide data related to the input signals generated by the input device of the desk unit to the master control unit, the data to control at least one of the one or more parameters of the observable outputs.

14. The communication system of claim 13, including a remote having a selector, the remote communicatively coupled to the master control unit, the selector operable to provide selection inputs to the remote that are operable to be transmitted to the master control unit, the selection inputs including selection data used by the master control unit to determine which of the plurality of desk units are selected and which of the desk units are un-selected.

15. The communication system of claim 13, wherein one or more of the desk units is a portable device.

16. The communication system of claim 15, further including a base station coupled to the communication system, the base unit operable to transmit an infrared beacon signal, wherein any of the one or more desk units include a receiver operable to receive the infrared beacon signal transmitted from a base station, and include a desk unit security feature that is operable to sound an audible alarm if the desk unit fails to detect the infrared beacon signal for a pre-determined length of time.
